(19) United States
(12) Patent Application Publication
(10) Pub. No.: US 2006/0066804 A1
(43) Pub. Date: Mar. 30, 2006

(54) Optical compensation film, elliptical polarizing plate and liquid crystal display

(75) Inventor: Tomoki Tasaka, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/233,042

(22) Filed: Sep. 23, 2005

(30) Foreign Application Priority Data
Sep. 24, 2004 (JP) P.2004-278125
Sep. 27, 2004 (JP) P.2004-279001

(51) Int. Cl. C09K 19/02

(52) U.S. Cl. 349/179

(57) ABSTRACT

An optical compensation film and an elliptical polarizing plate, for realizing a liquid crystal display improved in gray-scale inversion, having a wider viewing angle property and being excellent in industrial production is provided. An embodiment of the optical compensation film is characterized in that a liquid crystal composition capable of expressing a biaxial nematic phase has a twisted hybrid alignment. Another embodiment includes a transparent substrate, a first optically anisotropic layer and a second optically anisotropic layer in an arbitrary order, and is characterized in that the first optically anisotropic layer is formed by a liquid crystal composition capable of expressing a biaxial nematic phase, and the second optically anisotropic layer is formed by monoaxial liquid crystalline molecules.

### FIELD OF THE INVENTION

The present invention relates to an optical compensation film having an optically anisotropic layer formed by liquid crystalline molecules, and an elliptical polarizing plate and a liquid crystal display utilizing the same.

### BACKGROUND OF THE INVENTION

A liquid crystal display includes a liquid crystal cell, a polarizing element and an optical compensation film (retardation plate). In a liquid crystal display of transmission type, two polarizing elements are positioned on both sides of the liquid crystal cell, and one or two optical compensation films are positioned between the liquid crystal cell and the polarizing elements. In a liquid crystal display of reflective type, a reflecting plate, a liquid crystal cell, an optical compensation film and a polarizing element are provided in this order. The liquid crystal cell includes rod-shape liquid crystalline molecules, two substrates for sealing the liquid crystalline molecules therein, and electrode layers for applying a voltage to the rod-shape liquid crystalline molecules. The liquid crystal cell is proposed in various display modes, by a difference in the alignment state of the rod-shape liquid crystalline molecules, such as a TN (twisted nematic) mode, an IPS (in-plane switching) mode, an FLC (ferroelectric liquid crystal) mode, an OCB (optically compensated bend) mode, an STN (super switched nematic) mode, a VA (vertically aligned) mode or an ECB (electrically controlled birefringence) mode in the transmission type, or a TN mode, a HAN (hybrid aligned nematic) mode or a GH (guest-host) mode in the reflective type.

The optical compensation film is employed in various liquid crystal displays in order to resolve a coloration in the image and to expand a viewing angle. As the optical compensation film, there are generally employed a stretching birefringent polymer film and an optical compensation film having an optically anisotropic layer formed by liquid crystalline molecules. The optical properties of the optical compensation film are determined according to the optical properties of the liquid crystal cell, more specifically by the display modes as described above.

The liquid crystalline molecules allow to prepare an optical compensation film of various optical properties, corresponding to the various display mode of the liquid crystal cell. In the optical compensation film utilizing liquid crystalline molecules, ones corresponding to various display modes are already being proposed.

A retardation plate, utilizing a biaxial liquid crystal, particularly a retardation plate utilizing the biaxial liquid crystal in a hybrid alignment, is useful for a viewing angle compensation of a liquid crystal display (for example, JP-A No. 2002-174730 and JP-A No. 2002-207125). For realizing a state in which the biaxial liquid crystal is hybrid aligned, it is necessary to express a biaxial nematic phase (Nb phase).

However, an optical compensation film utilizing a hybrid alignment of a liquid crystal composition capable of expressing a biaxial nematic phase can realize a wide viewing angle but also involves a phenomenon that, when a display plane of the display is observed from a lower angled direction, a difference in the luminance of gradation levels constituting an image rapidly decreases with an increase in the angle from a normal line to the display plane, resulting in an inversion of certain gradation levels (such phenomenon being called a gray-scale inversion). It is required to suppress such gray-scale inversion.

### SUMMARY OF THE INVENTION

An object of an illustrative, non-limiting embodiment of the present invention is to provide an optical compensation film capable of reducing a gray-scale inversion (a phenomenon that, when a display plane of the display is observed from a lower angled direction, a difference in the luminance of gradation levels constituting an image rapidly decreases with an increase in the angle from a normal line to the display plane, resulting in an inversion of certain gradation levels) encountered when a compensation film utilizing a hybrid alignment of a liquid crystal composition capable of expressing a biaxial nematic phase and having wide and excellent viewing angle characteristics is utilized on a liquid crystal display for example of TN mode.

Another object is also to provide an elliptical polarizing plate or a liquid crystal display utilizing such an optical compensation film.

The aforementioned objects of the present invention have been attained by following inventions.

### First Embodiment

A-1. An optical compensation film including an optically anisotropic layer containing a liquid crystal composition, capable of expressing a biaxial nematic phase, in a state where a hybrid alignment and a twisted alignment are provided.

A-2. An optical compensation film including an optically anisotropic layer containing a liquid crystal composition capable of expressing a biaxial nematic phase, characterized in that the optically anisotropic layer is formed by fixing a biaxial nematic phase in which a twisted alignment is provided to a hybrid alignment.

A-3. An optical compensation film described in A-1 or A-2, characterized in that, the liquid crystal composition capable of expressing the biaxial nematic phase has refractive indexes nx, ny and nz in a decreasing order of three axes thereof, an angle of an axis of nx to a planar direction of the optical compensation film scarcely changes in a thickness direction of the optically anisotropic layer, and an angle of an axis of nz to a planar direction of the film changes in a thickness direction.

A-4. An optical compensation film described in any one of A-1 to A-3, characterized in that a twist angle of the twisted alignment is less than 10°.

A-5. An optical compensation film described in any one of A-1 to A-4, characterized in that the liquid crystal composition capable of expressing the biaxial nematic phase includes a liquid crystal compound capable of expressing a rod-shape liquid crystal phase and a liquid crystal compound capable of expressing a discotic liquid crystal phase.

A-6. An optical compensation film described in any one of A-1 to A-5, characterized in that the optical compensation film further includes: a substrate; and an alignment film between the substrate and the optically anisotropic layer, and the optically anisotropic layer is formed by stacking a layer of a liquid crystal composition, containing an optically active compound and a liquid crystal compound capable of expressing a biaxial nematic phase, and expressing and fixing the biaxial nematic phase.

A-7. An elliptical polarizing plate characterized in that an optical compensation film described in any one of A-1 to A-6, and a polarizing film are stacked on a transparent substrate.

A-8. A liquid crystal display including an optical compensation film described in any one of A-1 to A-6, or an elliptical polarizing plate described in A-7.

### Second Embodiment

B-1. An optical compensation film including: a transparent substrate; a first optically anisotropic layer; and a second optically anisotropic layer in an arbitrary order, characterized in that the first optically anisotropic layer contains a liquid crystal composition capable of expressing a biaxial nematic phase, and the second optically anisotropic layer contains a monoaxial liquid crystalline molecule.

B-2. An optical compensation film described in B-1, characterized in that the liquid crystal composition capable of expressing the biaxial nematic phase has a principal axis inclined to a surface of the transparent substrate.

B-3. An optical compensation film described in B-2, characterized in that the an inclination angle of the principal axis to the surface of transparent substrate changes unidirectionally according to a distance to the surface of the transparent substrate.

B-4. An optical compensation film described in B-1, characterized in that the monoaxial liquid crystalline molecule has an optical axis thereof inclined to a surface of the transparent substrate, and an inclination angle of the optical axis changes unidirectionally according to a distance to the surface of the transparent substrate.

B-5. An optical compensation film described in any one of B-1 to B-4, characterized in that the first optically anisotropic layer, the transparent substrate and the second optically anisotropic layer are stacked in this order.

B-6. An optical compensation film described in any one of B-1 to B-4, characterized in that the transparent substrate, the first optically anisotropic layer, and the second optically anisotropic layer are stacked in this order.

B-7. An optical compensation film described in any one of B-1 to B-6, characterized in that the first optically anisotropic layer contains a rod-shape liquid crystalline molecule.

B-8. An optical compensation film described in any one of B-1 to B-6, characterized in that the first optically anisotropic layer contains a discotic liquid crystalline molecule.

B-9. An elliptical polarizing plate including at least an optical compensation film described in any one of B-1 to B-8, a polarizing film and a transparent protective film, characterized in that the second optically anisotropic layer is stacked in a position closer to the polarizing film than the first optically anisotropic layer.

B-10. A liquid crystal display including at least a liquid crystal cell of TN mode and two polarizing elements positioned on both sides of the liquid crystal cell, characterized in that the two polarizing elements each contains at least an elliptical polarizing plate described in B-9.

An optical compensation film disclosed in the present invention, provided for example between a liquid crystal cell of TN mode and an upper/lower polarizing film, can improve the gray-scale inversion, generated in the lower viewing direction of the TN liquid crystal display and can realize a wider viewing angle property. A configuration of adding a twisting to a hybrid alignment of a liquid crystal composition capable of expressing a biaxial nematic phase allows to provide an optical compensation film and an elliptical polarizing plate excellent in industrial productivity thereby realizing a display apparatus, improved further in the display quality than in the prior technology.

Also a configuration of stacking a hybrid aligned layer of a liquid crystal composition capable of expressing a biaxial nematic phase and a layer containing monoaxial liquid crystalline molecules having a principal axis inclined to a surface of the transparent substrate allows to provide an optical compensation film and an elliptical polarizing plate excellent in industrial productivity thereby realizing a display apparatus, improved further in the display quality than in the prior technology.

### BRIEF DESCRIPTION OF THE DRAWINGS

FIGS. 1A-1B are illustrative, non-limiting schematic views showing an inclination angle and a twist angle.

FIGS. 2A-2C are illustrative, non-limiting schematic views showing a basic configuration of a transmission type liquid crystal display.

FIG. 3 is an illustrative, non-limiting schematic view showing a basic configuration of a reflective type liquid crystal display.

FIGS. 4A-4D are illustrative, non-limiting schematic views showing a basic configuration of a transmission type liquid crystal display.

FIG. 5 is an illustrative, non-limiting schematic view showing a basic configuration of a reflective type liquid crystal display.

### DETAILED DESCRIPTION OF THE INVENTION

In the following, contents of the present invention will be explained in detail. In the present description, a symbol “-” is used to indicate a range including numerical values written in front of and behind the symbol as a lower limit value and an upper limit value. Also, the terms “liquid crystal composition”, “liquid crystal compound” and “liquid crystal molecule” are sometimes referred to as “liquid crystalline composition”, “liquid crystalline compound” and “liquid crystalline molecule”, respectively.

As an optical compensation film is used by being inserted, stacked and optically contacted between a polarizing film and a liquid crystal layer for achieving a phase compensation of the liquid crystal layer, it is effective to prepare an elliptical polarizing plate in advance by adhering the polarizing film and the compensating optically anisotropic layer or the transparent substrate.

### First Embodiment

An exemplary film of the present invention is realized by adding a twisted alignment to a hybrid alignment of a liquid crystal composition capable of expressing a biaxial nematic phase.

In a biaxial nematic phase, principal refractive indexes in three orthogonal directions are represented by nx, ny and nz in the decreasing order.

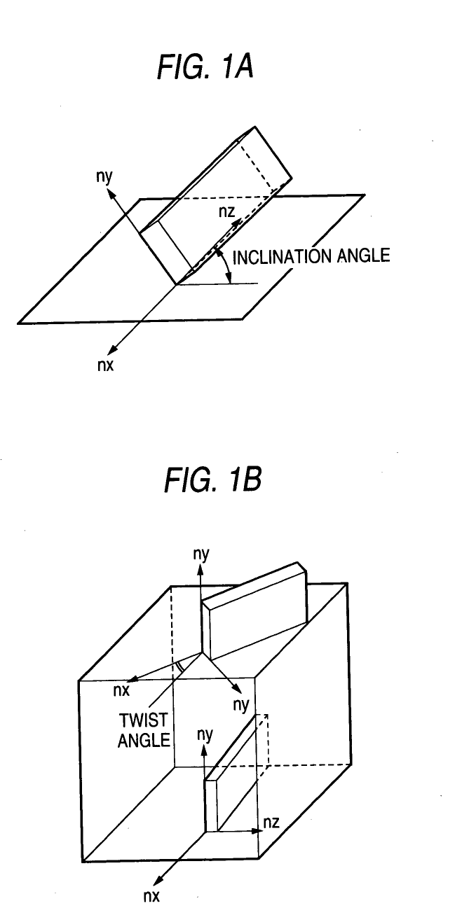

A hybrid alignment means that the directions of nx, ny and nz change continuously in the direction along the thickness of the layer (i.e., the thickness direction of the layer). FIG. 1A schematically illustrates such situation. A twisted alignment means that the directions of principal refractive indexes show a continuous rotational change within a plane of the film with respect to the thickness of the layer. FIG. 1B schematically illustrates such situation.

An inclination angle of the hybrid alignment and a twist angle of the twisted alignment increase or decrease, in the direction of depth in the optically anisotropic layer, with an increase in the distance from an interface with the transparent substrate. The inclination angle and the twisted angle preferably increase with an increase in such distance. Also the change in the inclination angle and the twisted angle may be a continuous increase, a continuous decrease, an intermittent increase, an intermittent decrease, a change including a continuous increase and a continuous decrease, or an intermittent change including an increase and a decrease. An intermittent change includes an area where the inclination angle and the twisted angle do not change, within a thickness. In the invention, there may be included an area where the inclination angle and the twisted angle do not change as long as an increase or a decrease is exhibited in the entire layer. It is further preferred that the inclination angle and the twisted angle show a continuous change.

The optical compensation film of the invention includes an optically anisotropic layer formed by a liquid crystal composition capable of expressing a biaxial nematic phase, preferably on a transparent substrate. It is further preferred that an alignment film is provided between the transparent substrate and the optically anisotropic layer. The optically anisotropic layer is formed by coating, on the alignment film, a liquid crystal composition capable of expressing a biaxial nematic phase and added with other additives if necessary, and then fixing the alignment of the liquid crystal state. In this operation, the liquid crystal composition capable of expressing a biaxial nematic phase is fixed in a state in which a twisted alignment is given to the hybrid alignment.

A hybrid alignment of the biaxial nematic phase includes, taking refractive indexes in three orthogonal directions as nx, ny and nz in the decreasing order, (i) a hybrid alignment in which directions of nx and ny change but a direction of nz does not change along the direction of film thickness (the thickness direction), (ii) a hybrid alignment in which directions of nx and nz change but a direction of ny does not change along the direction of film thickness, and (iii) a hybrid alignment in which directions of ny and nz change but a direction of nx does not change along the direction of film thickness. In consideration of a viewing angle compensation for a liquid crystal display, all such hybrid alignments cannot be considered preferable as there are included a preferable alignment and an unpreferable alignment, and, in case of employing the retardation plate as a viewing angle compensating plate for a liquid crystal display of TN (twisted nematic) mode or OCB (optically compensatory bend) mode, there is most preferred the hybrid alignment (iii) in which directions of ny and nz change but a direction of nx does not change along the direction of film thickness.

As the biaxial nematic phase is coated preferably on a substrate (more preferably on an alignment film), the liquid crystal compound is aligned, at an interface at the side of the substrate, with a tilt angle (angle to the planar direction of the transparent substrate) of a substrate surface or an interface of a coated film (an interface of an alignment film in case an alignment film is provided), and, at an interface with the air, aligned with a tilt angle of an air interface. A biaxial liquid crystal compound has three tilt angles, namely a tilt angle between a direction of nx and an interface, a tilt angle between a direction of ny and an interface, and a tilt angle between a direction of nz and an interface (tilt angle being defined with respect to an interface).

In the optically anisotropic layer of the invention, a tilt angle in the direction of nx is 0-10°, and preferably 0-5° at the interface with the air and at the interface at the side of substrate, and preferably scarcely changes along the direction of film thickness.

On the other hand, in the direction of ny, the tilt angle differs significantly between the air interface and the interface at the substrate side. Therefore, along the direction of film thickness, the tilt angle changes continuously from the air interface to the interface at the substrate side. The tilt angle in the direction of ny is preferably from 3 to 87° at the air interface and from 3 to 87° at the interface of the substrate side. In particular, an average inclination angle α of the tilt angle is preferably from 30 to 75°, more preferably from 35 to 72° and particularly preferably from 40 to 70°.

As the direction of nz is perpendicular to the direction of ny, a tilt angle in the direction of nz is preferably from 3 to 87° at the air interface and from 3 to 87° at the interface of the substrate side. In particular, an average inclination angle β of the tilt angle is preferably from 15 to 60°, more preferably from 18 to 55° and particularly preferably from 20 to 50°.

Thus, in the directions of ny and nz, a hybrid alignment is developed because the tilt angle differs between the air interface and the interface at the substrate side.

Other optical characteristics of the optically anisotropic layer are not particularly restricted and preferred ranges may be determined according to the intended application.

A film thickness is preferably 0.01 μm or larger but less than 50 μm, and more preferably 0.1 μm or larger but less than 5 μm. In general, an in-plane retardation Re is preferably 10-120 nm, and more preferably 30-90 nm. A retardation Rth in the direction of thickness is preferably 20-200 nm.

A ratio (nx−nz)/(nx−ny) in the biaxial nematic phase is preferably 1.01 or larger but less than 100, more preferably 1.2 or larger but less than 40 and further preferably 2.0 or larger but less than 30.

In the biaxial nematic phase, (nx−ny) and (ny−nz) are preferably larger for reducing the film thickness and improving the coating property, each preferably 0.001 or larger, more preferably 0.01 or larger and further preferably 0.03 or larger.

For determining refractive indexes in three direction of a liquid crystal phase, reference can be made for example to a report by Sakai (“Birefringence analysis of a film by automatic birefringence meter”, Plastics, vol. 51, No. 3, 57(2000)).

A twisted alignment may assume various configurations. A twisting angle, taking the liquid crystal cell side as a reference, is preferably 0.1° or larger but less than 10° at the polarizing film side, more preferably 0.25° or larger but less than 50, and further preferably 0.5° or larger but less than 4°.

The twisted alignment in the optically anisotropic layer is preferably less than 1 pitch. A direction of the twisted alignment may be clockwise or counterclockwise, but is selected opposite to the direction of twisting of the liquid crystal in the liquid crystal cell which is an object of the optical compensation.

For providing a twisted alignment, an optically active compound is mixed in the liquid crystal compound capable of expressing a biaxial nematic phase to express a biaxial nematic phase having a twisted alignment. The biaxial nematic phase having a twisted alignment may also be expressed by employing a liquid crystal compound having an asymmetric center.

The optically active compound can be a chiral agent (described for example in Liquid Crystal Device Handbook, Chap. 3, 4-3, Chiral agent for TN and STN, p. 199, Nippon Gakujutsu Shinko-kai, Committee No. 142, 1989). The optically active compound generally contains an asymmetric carbon atom, but an axially asymmetric compound or a planar asymmetric compound, not containing an asymmetric carbon atom, may also be employed as a chiral agent. Examples of the axially asymmetric compound and the planar asymmetric compound include binaphthyl, helicene, paracyclophane and derivatives thereof. The optically active compound (chiral agent) may include a polymerizable group.

An amount of the optically active compound is preferably 0.01 to 200 mol. % of the amount of the liquid crystal compound capable of expressing a biaxial nematic phase.

By defining a direction of the optically anisotropic layer, formed by a hybrid alignment of the liquid crystal compound capable of expressing a biaxial nematic phase, as a projected direction of the direction of nx onto the plane of the substrate, a combination with a direction of an absorbing axis of the polarizing film may be selected a substantially parallel relationship or a substantially perpendicular relationship. A substantially parallel or perpendicular relationship means an angular aberration preferably within 20°, more preferably within 10°. A perpendicular relationship is preferred.

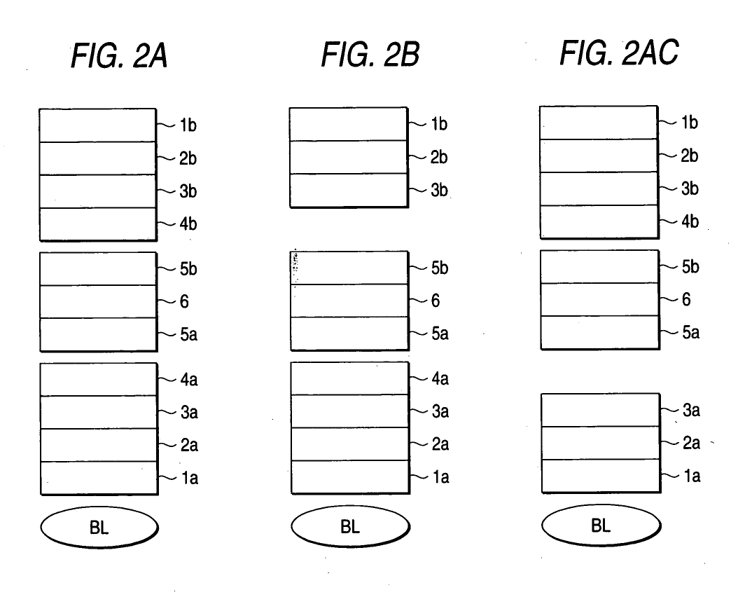

In the following, examples of the optical compensation film of the invention are shown, but for example an order of stacked layers is not limited to such examples. FIGS. 2A-2C are schematic view showing a basic structure of a transmission type liquid crystal display. A transmission liquid crystal display shown in FIG. 2A includes, from the side of a backlight (BL), a transparent protective film (1a), a polarizing film (2a), a transparent substrate (3a), an optically anisotropic layer (4a), a lower substrate (5a) of a liquid crystal cell, rod-shape liquid crystalline molecules (6), an upper substrate (5b) of the liquid crystal cell, an optically anisotropic layer (4b), a transparent substrate (3b), a polarizing film (2b) and a transparent protective film (1b).

The transparent protective film, the polarizing film, the transparent substrate and the optically anisotropic layer (1a-4a or 4b-1b) constitute an optical compensation film.

A transmission liquid crystal display shown in FIG. 2B includes, from the side of a backlight (BL), a transparent protective film (1a), a polarizing film (2a), a transparent substrate (3a), an optically anisotropic layer (4a), a lower substrate (5a) of a liquid crystal cell, rod-shape liquid crystalline molecules (6), an upper substrate (5b) of the liquid crystal cell, a transparent substrate (3b), a polarizing film (2b) and a transparent protective film (1b). The transparent protective film, the polarizing film, the transparent substrate and the optically anisotropic layer (1a-4a) constitute an elliptical polarizing plate.

A transmission liquid crystal display shown in FIG. 2C includes, from the side of a backlight (BL), a transparent protective film (1a), a polarizing film (2a), a transparent substrate (3a), a lower substrate (5a) of a liquid crystal cell, rod-shape liquid crystalline molecules (6), an upper substrate (5b) of the liquid crystal cell, an optically anisotropic layer (4b), a transparent substrate (3b), a polarizing film (2b) and a transparent protective film (1b). The optical anisotropic layer and the transparent substrate constitute an optical compensation film. Also the transparent protective film, the polarizing film, the transparent substrate and the optically anisotropic layer (1a-4a) constitute an elliptical polarizing plate.

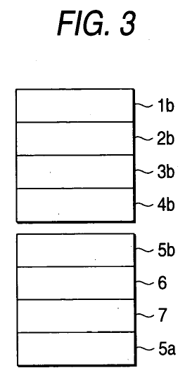

FIG. 3 is a schematic view showing a basic structure of a reflective type liquid crystal display. A reflective liquid crystal display shown in FIG. 3 includes, from the lower side, a lower substrate (5a) of a liquid crystal cell, a reflecting plate (7), rod-shape liquid crystalline molecules (6), an upper substrate (5b) of the liquid crystal cell, an optically anisotropic layer (4b), a transparent substrate (3b), a polarizing film (2b) and a transparent protective film (1b).

The transparent substrate and the optical anisotropic layer (4b-3b) constitute an optical compensation film. Also the transparent protective film, the polarizing film, the transparent substrate and the optically anisotropic layer (4b-1b) constitute an elliptical polarizing plate.

An inclination angle of the hybrid alignment of the film and a twist angle of the twisted alignment can be determined by executing ellipsometry in various directions and by comparing the results with a simulation by an extended Jones method (for example P. Yeh et al., Optics of liquid crystal displays, 1999, p. 306). Also a film thickness can be determined by a calculation in combination with the refractive index of the liquid crystal.

### Second Embodiment

As an optical compensation film is used by being inserted, stacked and optically contacted between the polarizing film and the liquid crystal layer for achieving a phase compensation of the liquid crystal layer, it is effective to prepare an elliptical polarizing plate in advance by adhering a polarizing film, a first optically anisotropic layer for phase compensation (layer of a liquid crystal composition capable of expressing a biaxial nematic phase), a second optically anisotropic layer (monoaxial liquid crystal layer) and a transparent substrate. In this case, the order of the stacking can be selected suitably, but it is preferable to provide the first optically anisotropic layer in a position close to the liquid crystal layer, and to provide the second optically anisotropic layer in a position closer to the polarizing film, in order to improve the gray-scale inversion and to realize a wide viewing angle.

A film of the present invention is preferably realized by stacking a hybrid aligned layer of a liquid crystal composition capable of expressing a biaxial nematic phase, and an inclined layer of monoaxial liquid crystalline molecules.

In the first optically anisotropic layer, the biaxial nematic phase expressed by the liquid crystal composition preferably has a principal axis inclined to the surface of the transparent substrate. When principal refractive indexes in three orthogonal directions in the biaxial nematic phase are taken as nx, ny and nz in the decreasing order, it is preferable that either one of the directions of nx, ny and nz is inclined to the surface of the transparent substrate.

It is further preferred that, in the biaxial nematic phase, a principal axis is inclined to the surface of the transparent substrate and that the inclination angle changes unidirectionally according to a distance to the surface of the transparent substrate, namely a hybrid alignment being realized.

A hybrid alignment means that the directions of nx, ny and nz change continuously in the direction across the thickness of the layer. FIG. 1A schematically illustrates such situation.

An inclination angle of the hybrid alignment increases or decreases, in the direction of depth in the optically anisotropic layer, with an increase in the distance from an interface with the transparent substrate. The inclination angle preferably increases with an increase in such distance. Also the change in the inclination angle may be a continuous increase, a continuous decrease, an intermittent increase, an intermittent decrease, a change including a continuous increase and a continuous decrease, or an intermittent change including an increase and a decrease. An intermittent change includes an area where the inclination angle does not change, within the thickness. In the invention, there may be included an area where the inclination angle does not change as long as an increase or a decrease is exhibited in the entire layer. It is further preferred that the inclination angle shows a continuous change.

The optical compensation film of the invention includes a first optically anisotropic layer formed by a liquid crystal composition capable of expressing a biaxial nematic phase, on a transparent substrate. It is further preferred that an alignment film is provided between the transparent substrate and the first optically anisotropic layer. The first optically anisotropic layer is formed by coating, on the alignment film, a liquid crystal composition capable of expressing a biaxial nematic phase and added with other additives if necessary, and then fixing the alignment of the liquid crystal state. In this operation, the liquid crystal composition capable of expressing a biaxial nematic phase is fixed in a hybrid alignment state.

In the optical compensation film of the invention, the first optically anisotropic layer is preferably prepared by fixing a biaxial nematic phase in a hybrid aligned state. A hybrid alignment of the biaxial nematic phase includes, taking refractive indexes in three orthogonal directions as nx, ny and nz in the decreasing order, (i) a hybrid alignment in which directions of nx and ny change but a direction of nz does not change along the direction of film thickness, (ii) a hybrid alignment in which directions of nx and nz change but a direction of ny does not change along the direction of film thickness, and (iii) a hybrid alignment in which directions of ny and nz change but a direction of nx does not change along the direction of film thickness. In consideration of a viewing angle compensation for a liquid crystal display, all such hybrid alignments cannot be considered preferable as there are included a preferable alignment and an unpreferable alignment, and, in case of employing the retardation plate as a viewing angle compensating plate for a liquid crystal display of TN (twisted nematic) mode or OCB (optically compensatory bend) mode, there is most preferred the hybrid alignment (iii) in which directions of ny and nz change but a direction of nx does not change along the direction of film thickness.

As the biaxial nematic phase is coated preferably on a substrate (more preferably on an alignment film), the liquid crystal compound is aligned, at an interface at the side of the substrate, with a tilt angle (angle to the planar direction of the transparent substrate) of a substrate surface or an interface of a coated film (an interface of an alignment film in case an alignment film is provided), and, at an interface with the air, aligned with a tilt angle of an air interface. A biaxial liquid crystal compound has three tilt angles, namely a tilt angle between a direction of nx and an interface, a tilt angle between a direction of ny and an interface, and a tilt angle between a direction of nz and an interface (tilt angle being defined with respect to an interface).

In the first optically anisotropic layer of the invention, a tilt angle in the direction of nx is 0-10°, and preferably 0-5° at the interface with the air and at the interface at the side of substrate, and preferably scarcely changes along the direction of film thickness.

On the other hand, in the direction of ny, the tilt angle differs significantly between the air interface and the interface at the substrate side. Therefore, along the direction of film thickness, the tilt angle changes continuously from the air interface to the interface at the substrate side. The tilt angle in the direction of ny is preferably from 3° to 87° at the air interface and from 3° to 87° at the interface of the substrate side. In particular, an average inclination angle β of the tilt angle is preferably from 30° to 75°, more preferably from 350 to 72° and particularly preferably from 40° to 700.

As the direction of nz is perpendicular to the direction of ny, a tilt angle in the direction of nz is preferably from 3° to 87° at the air interface and from 3° to 87° at the interface of the substrate side. In particular, an average inclination angle β of the tilt angle is preferably from 15° to 60°, more preferably from 18° to 55° and particularly preferably from 200 to 500.

Thus, in the directions of ny and nz, a hybrid alignment is developed because the tilt angle differs between the air interface and the interface at the substrate side.

Other optical characteristics of the first optically anisotropic layer are not particularly restricted and preferred ranges thereof may be determined according to the intended application.

A film thickness is preferably 0.01 μm or larger but less than 50 μm, and more preferably 0.1 μm or larger but less than 5 μm.

In general, an in-plane retardation Re is preferably 10-120 nm, and more preferably 30-90 nm. A retardation Rth in the direction of thickness is preferably 20-200 nm.

A ratio (nx−nz)/(nx−ny) in the biaxial nematic phase is preferably 1.01 or larger but less than 100, more preferably 1.2 or larger but less than 40 and further preferably 2.0 or larger but less than 30.

In the biaxial nematic phase, (nx−ny) and (ny−nz) are preferably larger for reducing the film thickness and improving the coating property, each preferably 0.001 or larger, more preferably 0.01 or larger and further preferably 0.03 or larger.

For determining refractive indexes in three direction of a liquid crystal phase, reference can be made for example to a report by Sakai (“Birefringence analysis of a film by automatic birefringence meter”, Plastics, vol. 51, No. 3, 57(2000)).

An average inclination angle β of the hybrid alignment of the film can be determined by an ellipsometry, by a following method. An in-plane retardation (Δnd) of the film is measured, and an angle where Δnd becomes an extinction point is taken as an average inclination angle β. The extinction employed herein not only means that the transmitted light becomes zero strictly, but also an angle where the transmitted light becomes minimum. In the hybrid alignment, the transmitted light does not become 0 because of absence of an optical axis.

A monoaxial liquid crystal (monoaxial liquid crystalline molecules) in the second optically anisotropic layer of the invention may be a rod-shape liquid crystal having a positive refractive index anisotropy or a discotic liquid crystal having a negative refractive index anisotropy, but there is preferred a rod-shape liquid crystal having a positive refractive index anisotropy.

An angle of the inclined layer of the monoaxial liquid crystal is defined as an angle formed by the film surface and an optical axis of the liquid crystal. An inclination angle of the monoaxial liquid crystal, in case of a rod-shape liquid crystal having a positive refractive index anisotropy, is preferably 45° to 90°, more preferably 50° to 70°. In case of a discotic liquid crystal having a negative refractive index anisotropy, it is preferably 0° to 48°, more preferably 30° to 400.

The inclination angle of the monoaxial liquid crystal may be constant in the thickness direction of the layer, or may assume a hybrid alignment (inclination angle showing a unidirectional change according to a distance to the surface of the transparent substrate). In case of the hybrid alignment, the aforementioned range of the inclination angle is replaced by the average inclination angle β. Other optical characteristics of the second optically anisotropic layer are not particularly restricted and preferred ranges thereof may be determined according to the intended application.

A film thickness is preferably 0.01 μm or larger but less than 50 μm, and more preferably 0.1 μm or larger but less than 5 μm.

In general, an in-plane retardation Re is preferably 10-120 nm, and more preferably 30-90 nm. A retardation Rth in the direction of thickness is preferably 20-200 nm.

The second optically anisotropic layer containing the monoaxial liquid crystal preferably has a larger An for reducing the film thickness and improving the coating property, preferably 0.001 or larger, more preferably 0.01 or larger and further preferably 0.03 or larger.

A combination of an average direction of a line obtained by projecting nx of the first optically anisotropic layer onto the transparent substrate, or an average direction of a line obtained by projecting an optical axis of the monoaxial liquid crystal of the second optically anisotropic layer onto the transparent substrate, and a direction of an absorbing axis of the polarizing film may be selected a substantially parallel relationship or a substantially perpendicular relationship. A substantially parallel or perpendicular relationship means an angular aberration preferably within 20°, more preferably within 10° (hereinafter same meaning being adopted).

The average direction of a line obtained by projecting nx of the first optically anisotropic layer onto the transparent substrate, and the average direction of a line obtained by projecting the optical axis of the monoaxial liquid crystal of the second optically anisotropic layer onto the transparent substrate each preferably forms an angle of 80° to 100° with the direction of the absorbing axis of the polarizing film, in achieving a wide viewing angle.

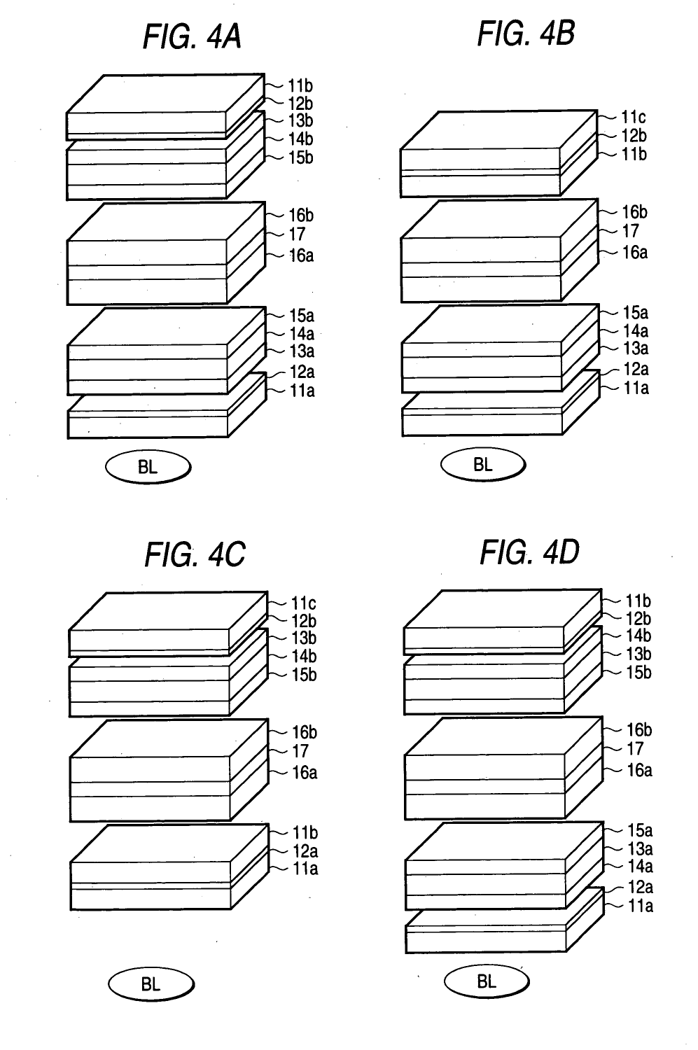

In the following, examples of the optical compensation film of the invention are shown, but for example an order of stacked layers is not limited to such examples. FIGS. 4A-4D are schematic view showing a basic structure of a transmission type liquid crystal display. A transmission liquid crystal display shown in FIG. 4A includes, from the side of a backlight (BL), of a transparent protective film (11a), a polarizing film (12a), a second optically anisotropic layer (13a), a transparent substrate (14a), a first optically anisotropic layer (15a), a lower substrate (16a) of a liquid crystal cell, rod-shape liquid crystalline molecules (17), an upper substrate (16b) of the liquid crystal cell, a first optically anisotropic layer (15b), a transparent substrate (14b), a second optically anisotropic layer (13b), a polarizing film (12b) and a transparent protective film (11b). The second optically anisotropic layer, the transparent substrate and the first optically anisotropic layer (13a-15a or 15b-13b) constitute an optical compensation film. Also the transparent protective film, the polarizing film, the second optically anisotropic layer, the transparent substrate and the first optically anisotropic layer (11a-15a or 15b-11b) constitute an optical compensation film.

A transmission liquid crystal display shown in FIG. 4B includes, from the side of a backlight (BL), a transparent protective film (11a), a polarizing film (12a), a second optically anisotropic layer (13a), a transparent substrate (14a), a first optically anisotropic layer (15a), a lower substrate (16a) of a liquid crystal cell, rod-shape liquid crystalline molecules (17), an upper substrate (16b) of the liquid crystal cell, a transparent protective film (11b), a polarizing film (12b) and a transparent protective film (11c). The transparent protective film, the polarizing film, the second optically anisotrpic layer, the transparent substrate and the first optically anisotropic layer (11a-15a) constitute an elliptical polarizing plate.

A transmission liquid crystal display shown in FIG. 4C includes, from the side of a backlight (BL), of a transparent protective film (11a), a polarizing film (12a), a transparent protective film (11b), a lower substrate (16a) of a liquid crystal cell, rod-shape liquid crystalline molecules (17), an upper substrate (16b) of the liquid crystal cell, a first optically anisotropic layer (15b), a transparent substrate (14b), a second optically anisotropic layer (13b), a polarizing film (12b) and a transparent protective film (11c). The first optical anisotropic layer, the transparent substrate and the second optically anisotropic layer (15b-13b) constitute an optical compensation film. Also the transparent protective film, the polarizing film, the second optically anisotropic layer, the transparent substrate and the first optically anisotropic layer (11c-15b) constitute an elliptical polarizing plate.

A transmission liquid crystal display shown in FIG. 4D includes, from the side of a backlight (BL), a transparent protective film (11a), a polarizing film (12a), a transparent substrate (14b), a second optically anisotropic layer (13a), a first optically anisotropic layer (15a), a lower substrate (16a) of a liquid crystal cell, rod-shape liquid crystalline molecules (17), an upper substrate (16b) of the liquid crystal cell, a first optically anisotropic layer (15b), a second optically anisotropic layer (13b), a transparent substrate (14b), a polarizing film (12b) and a transparent protective film (11b). The transparent substrate, the second optically anistropic layer and the first optically anisotropic layer (14a-15a or 15b-14b) constitute an optical compensation film. Also the transparent protective film, the polarizing film, the transparent substrate, the second optically anisotropic layer, and the first optically anisotropic layer (11a-15a or 15b-11b) constitute an optical compensation film.

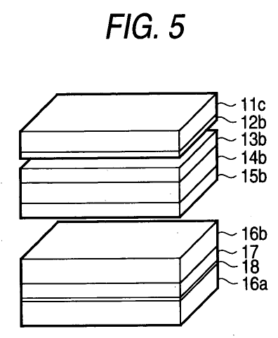

FIG. 5 is a schematic view showing a basic structure of a reflective type liquid crystal display. A reflective liquid crystal display shown in FIG. 5 includes, from the lower side, a lower substrate (16a) of a liquid crystal cell, a reflecting plate (18), rod-shape liquid crystalline molecules (17), an upper substrate (16b) of the liquid crystal cell, a first optically anisotropic layer (15b), a transparent substrate (14b), a second optically anisotropic layer (13b), a polarizing film (12b) and a transparent protective film (11c).

The second optically anisotropic layer, the transparent substrate and the first optically anisotropic layer (13b-15b) constitute an optical compensation film. Also the transparent protective film, the polarizing film, the second optically anisotropic layer, the transparent substrate and the first optically anisotropic layer (11c-15b) constitute an elliptical polarizing plate.

An optical compensation film or an elliptical polarizing plate shown in FIGS. 4 and 5 belongs to a first aspect at least including a first optically anisotropic layer formed by a liquid crystal composition capable of expressing a biaxial nematic phase, and a second optically anisotropic layer formed by a monoaxial liquid crystal. In the optical compensation film of the first aspect, the transparent substrate, the first optically anisotropic layer and the second optically anisotropic layer are not particularly restricted in an order of the stacking thereof. However, in case of use in a liquid crystal cell, in order to meet the requirements for the gray-scale inversion and the viewing angle, there is preferred a stacking order of polarizing film→second optically anisotropic layer→transparent substrate→first optically anisotropic layer→liquid crystal cell or a stacking order of polarizing film→transparent substrate→second optically anisotropic layer→first optically anisotropic layer→liquid crystal cell. Thus, the optical compensation film preferably has a stacking order of second optically anisotropic layer→transparent substrate→first optically anisotropic layer or a stacking order of transparent substrate→second optically anisotropic layer→first optically anisotropic layer. In the second aspect, in place for the first and second optically anisotropic layers in the optical compensation film or the elliptical polarizing plate shown in FIGS. 4 and 5, an optically anisotropic layer formed by a liquid crystal composition capable of expressing a biaxial nematic phase and a monoaxial liquid crystal is provided in the position of the first optically anisotropic layer in FIGS. 4A-4D.

(Optically Anisotropic Layer)

The first optically anisotropic layer in the invention is formed by a liquid crystal composition capable of expressing a biaxial nematic phase. The second optically anisotropic layer is formed by a monoaxial liquid crystal (monoaxial liquid crystalline molecules). A specific alignment state of the liquid crystalline molecules (liquid crystal composition capable of expressing a biaxial nematic phase and monoaxial liquid crystal) can be controlled by a type of the liquid crystalline molecules, a type of an alignment film and an additive (such as plasticizer, binder, and surfactant) in the optically anisotropic layer. The liquid crystalline molecules are preferably fixed in an aligned state. The fixation of the aligned state can be executed with a polymer binder, but is preferably achieved by a polymerization reaction.

It is preferable, as explained above, to first compensate the liquid crystal cell substantially optically with the liquid crystal composition capable of expressing a biaxial nematic phase, namely optically compensating a major part of the rod-shape liquid crystalline molecules in the liquid crystal cell, and secondly to utilize the monoaxial liquid crystal in complementary manner so as not to generate a gray-scale inversion. An angle between an average direction of a line obtained by projecting nx of the liquid crystal composition capable of expressing a biaxial nematic phase onto the transparent substrate, and an average direction of a line obtained by projecting the longer axis of the monoaxial liquid crystal onto the transparent substrate is preferably within a range of 80° to 100°, and it is also possible to more effectively achieve an improvement in the gray-scale inversion and in the viewing angle property, by displacing such angle from 90° by 0-10°, more preferably by 2.5-7.5°.

Also the average direction of a line obtained by projecting the longer axis of the monoaxial liquid crystal onto the transparent substrate is preferably positioned, in case the transparent substrate has an optically monoaxial property or an optically biaxial property, substantially parallel or perpendicular to a phase retarding axis in the plane of the transparent substrate.

(Monoaxial Liquid Crystal Composition)

A discotic liquid crystalline molecule of the monoaxial liquid crystal layer employable in the invention is described in known literatures (such as C. Destrade et al., Mol. Crysr. Liq. Cryst., vol. 71, page 111(1981); The Chemical Society of Japan, Kikan Kagaku Sosetsu, No. 22, Chemistry of Liquid Crystal, chap. 5, chap. 10, para. 2(1994); B. Kohne et al., Angew. Chem. Soc. Chem. Comm., p. 1794(1985); and J. Zhang et al., J. Am. Chem. Soc., vol. 116, p. 2655(1994)). A polymerization of the discotic liquid crystalline molecules can utilize a method described in JP-A No. 8-27284. In order to fix the discotic liquid crystalline molecules by a polymerization, it is preferable to bond a polymerizable group as a substituent on a disk-shaped core of the discotic liquid crystalline molecule. However, a direct bonding of the polymerizable group to the disk-shaped core may cause a difficulty in maintaining the aligned state in the polymerization reaction. It is therefore preferable to introduce a connecting group between the disk-shaped core and the polymerizable group. Therefore, the discotic liquid crystalline molecule is preferably a compound represented by a following formula (I):
D(-L-Q)ₙ formula (I)
wherein D represents a disk-shaped core; L represents a divalent connecting group; Q represents a polymerizable group; and n is an integer of 4-12. In the formula (I), preferred examples of the disk-shaped core (D), the divalent connecting group (L) and the polymerizable group (Q) include (D1)-(D15), (L1) to (L25) and (Q1) to (Q17) described in JP-A No. 2000-304930, and the description therein on the disk-shaped core (D), the divalent connecting group (L) and the polymerizable group (O) can be employed advantageously.

The rod-shape liquid crystalline molecule in the monoaxial liquid crystal layer can preferably be an azomethine, an azoxy compound, a cyanobiphenyl, a cyanophenyl ester, a benzoate ester, a cyclohexanecarboxylate phenyl ester, a cyanophenylcyclohexane, a cyano-substituted phenylpyrimidine, an alkoxy-substituted phenylpyrimidine, a phenyldioxane, a tolan or an alkenylcyclohexyl benzonitrile. The rod-shape liquid crystalline molecule also includes a metal complex. The rod-shape liquid crystalline molecule can be those described in The Chemical Society of Japan, Kikan Kagaku Sosetsu, vol. 2, Chemistry of Liquid Crystal, chap. 7 and 1, para. 5(1994) and Liquid Crystal Handbook, Nihon Gakujutu Shinko-kai, Committee No. 142, chap. 3. The rod-shape liquid crystalline molecule preferably has a birefringence of 0.001-0.7. Also the rod-shape liquid crystalline molecule preferably has a polymerizable group. Examples of the polymerizable group are similar to those for the polymerizable group (O) of the discotic liquid crystalline molecule. The rod-shape liquid crystalline molecule preferably has a molecular structure substantially symmetrical with respect to a shorter axis. For this purpose, it preferably has polymerizable groups on both ends of the rod-shape molecular structure. Preferred examples of the rod-shape liquid crystalline molecule include (N1)-(N47) described in JP-A No. 2000-304930.

(Biaxial Liquid Crystal Composition)

A liquid crystal composition employed in the optically anisotropic layer in the first embodiment or in the first optically anisotropic layer in the second embodiment expresses a biaxial nematic phase. The biaxial nematic phase is one of liquid crystal phases which a nematic liquid crystal compound can assume, and indicates a state where, by defining a space of the liquid crystal phase by x-, y- and z-axes, the liquid crystal compound (liquid crystalline molecule) is inhibited from a free rotation of an x-z plane about the y-axis and also from a free rotation of an x-y plane about the z-axis. The biaxial nematic phase is preferable as it can easily aline the liquid crystalline molecule and does not easily show an alignment defect.

The liquid crystal composition capable of expressing a biaxial nematic phase in the invention includes a compound capable of expressing a liquid crystal (liquid crystal compound). Such liquid crystal compound can be a liquid crystal compound of a type capable of expressing a biaxial nematic phase, or a combination of liquid crystal compounds of two or more types, capable of expressing a biaxial nematic phase. For example, it is also possible to employ, in combination, a polymerizable biaxial liquid crystal compound a non-polymerizable biaxial liquid crystal compound. It is furthermore possible to employ, in combination, a low-molecular weight liquid crystal compound and a high-molecular weight liquid crystal compound. It is furthermore possible to employ a biaxial liquid crystal mixture of compounds which do not express a biaxial liquid crystal phase singly but become capable of expressing a biaxial liquid crystal phase by mixing two or more types. Also the liquid crystal compound may be a low-molecular weight compound or a high-molecular weight compound.

Furthermore, there may be included, in addition to the liquid crystal compound, additives that may be added at the formation of an optically anisotropic layer to be explained later (additives being an air-interface alignment controlling agent, an antirepellency agent, a polymerization initiator, a polymerizable monomer, a solvent and the like).

In the following, there will be shown specific examples of the low-molecular weight liquid crystal compound advantageously employable in the invention, but the present invention is not limited to such examples.

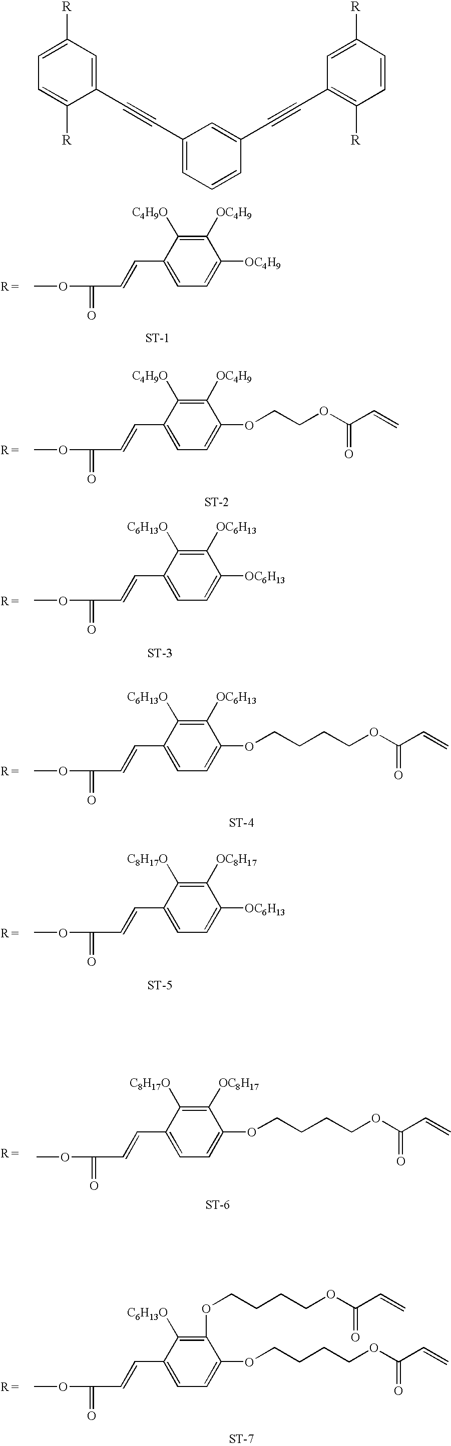

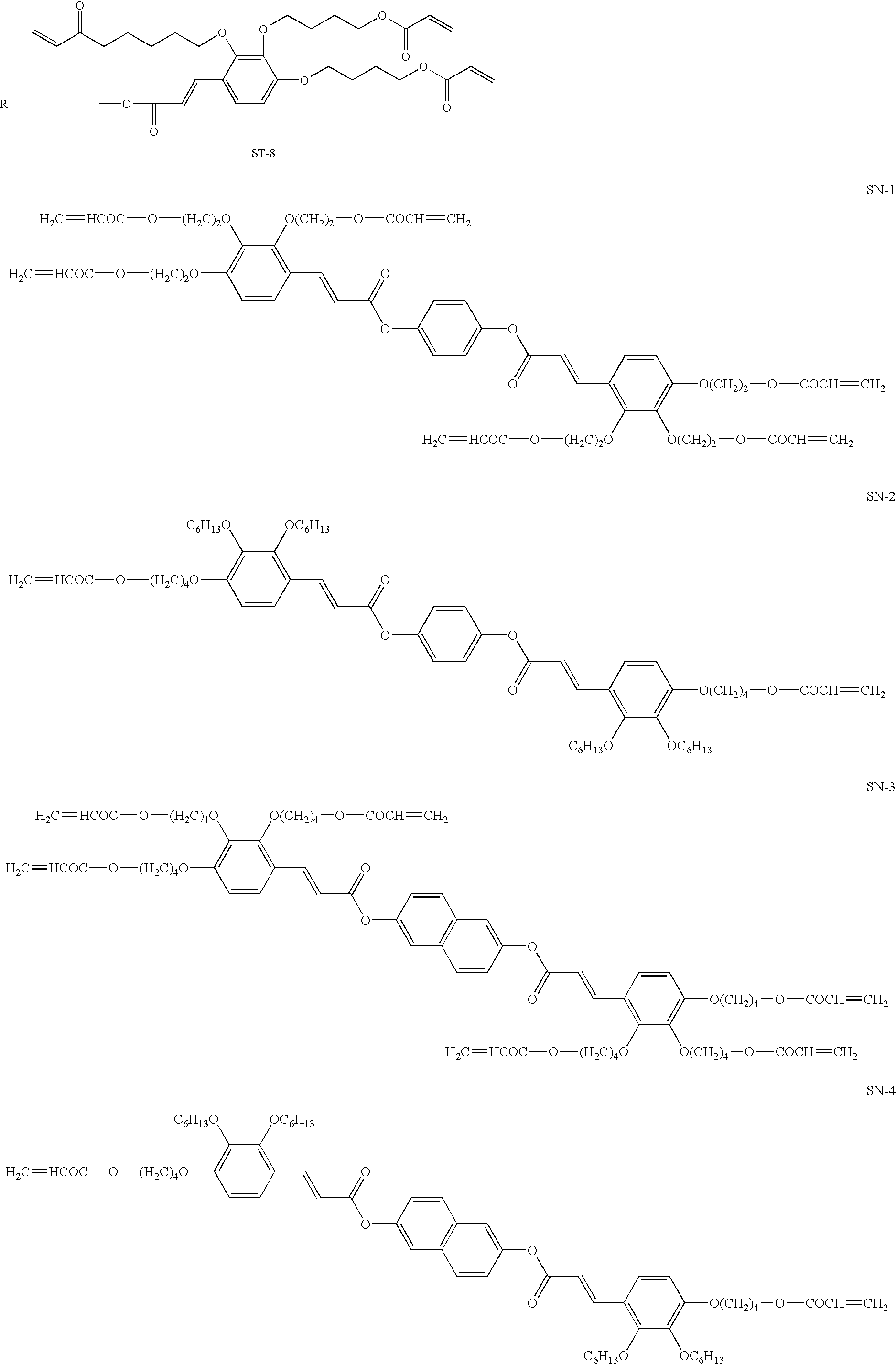

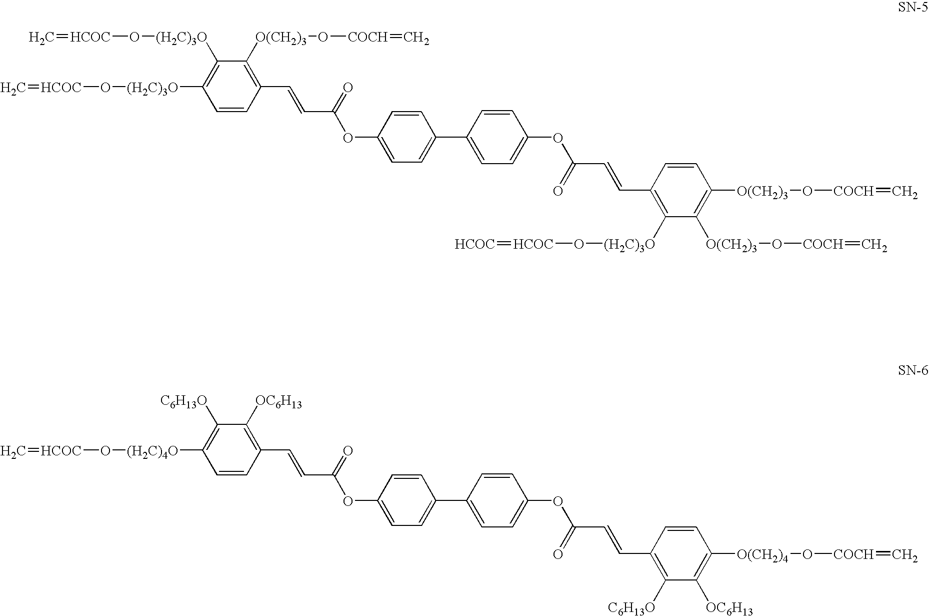

A liquid crystal compound capable of expressing a biaxial nematic phase is preferably capable of easy control of a value (nx−nz)/(nx−ny) in the biaxial liquid crystal phase. From such standpoint, the liquid crystal compound capable of expressing a biaxial nematic phase is preferably a liquid crystal mixture of a liquid crystal compound expressing a rod-shape liquid crystal phase capable of easy control of a value (nx−nz)/(nx−ny) as will be explained later and a liquid crystal compound capable of expressing a discotic liquid crystal phase, and, most preferably a mixture of a liquid crystal compound capable of expressing a nematic phase and a liquid crystal compound capable of expressing a discotic nematic phase.

(Liquid Crystal Compound Capable of Expressing Rod-Shape Liquid Crystal Phase)

A rod-shape liquid crystal phase can be a nematic phase, a smectic A phase or a smectic C phase expressed by a rod- or plate-shaped liquid crystal compound. Such liquid crystal phase is a monoaxial liquid crystal phase having a positive birefringence, satisfying a relation nx>ny=nz. Details are described for example in Ekisho Binran (Maruzen, 2000), and the rod-shape liquid crystal phase in the present invention is preferably a nematic phase.

On the other hand, there is also known a liquid crystal phase which is difficult to judge whether it is monoaxial or biaxial. For example, a liquid crystal phase described by D. Demus, J. Goodby et al., (Handbook of Liquid Crystals, vol. 2B: Low Molecular Weight Liquid Crystals II, pp. 933-943: Wiley-VCH) can be considered as a liquid crystal phase of difficult judgment. The liquid crystal compound expressing a rod-shape liquid crystal phase includes also such compound which is difficult to judge whether it is monoaxial or biaxial.

The liquid crystal compound expressing the rod-shape liquid crystal phase may be a low-molecular weight liquid crystal compound or a high-molecular weight liquid crystal compound, but is preferably a low-molecular weight liquid crystal compound in consideration of a mutual solubility with the liquid crystal compound expressing a discotic liquid crystal phase.

The liquid crystal compound expressing a rod-shape liquid crystal phase is preferably a liquid crystal compound capable of expressing a monoaxial liquid crystal phase having a positive birefringence, which can be an azomethine, an azoxy compound, a cyanobiphenyl, a cyanophenyl ester, a benzoate ester, a cyclohexanecarboxylate phenyl ester, a cyanophenylcyclohexane, a cyano-substituted phenylpyrimidine, an alkoxy-substituted phenylpyrimidine, a phenyldioxane, a tolan or an alkenylcyclohexyl benzonitrile.

The liquid crystal compound capable of expressing a rod-shape liquid crystal phase preferably has a substituent capable of an interaction (such as a hydrogen bonding or a dipole interaction) or an interaction capable of forming a covalent bond (such as a polymerizable group), with the liquid crystal compound capable of expressing a discotic liquid crystal phase. Presence of such substituent improves, when the liquid crystal compound expressing a rod-shape liquid crystal phase and the liquid crystal compound expressing a discotic liquid crystal phase are mixed, a mutual solubility of such liquid crystal compounds, thereby avoiding a phase separation into phases of respective compositions. For a similar reason, the liquid crystal compound expressing a discotic liquid crystal phase preferably has a similar group.

The liquid crystal compound capable of expressing a rod-shape liquid crystal phase preferably has a polymerizable group, and more preferably has a polymerizable group at a terminal end of a molecule of the compound. Presence of the polymerizable group is preferred since, in addition to the prevention of a phase separation from the liquid crystal compound expressing the discotic liquid crystal phase as described above, it can prevent a change in a phase difference (retardation) by heat or the like, in case the liquid crystal composition of the invention is employed in a retardation plate or the like.

A monoaxial liquid crystal compound having a polymerizable group and showing a positive birefringence can be compounds described for example in Makromol. Chem., vol. 190, p. 2255(1989), Advanced Materials, vol. 5, p. 107(1993), U.S. Pat. Nos. 4,683,327, 5,622,647 and 7,770,107, WO Nos. 95/22586, 95/24455, 97/00600, 98/23580 and 98/52905, JP-A Nos. 1-272551, 6-16616, 7-110469, 11-80081 and 2001-328973.

In the following, preferred examples of the polymerizable group in the liquid crystal compound capable of expressing a rod-shape liquid crystal phase.

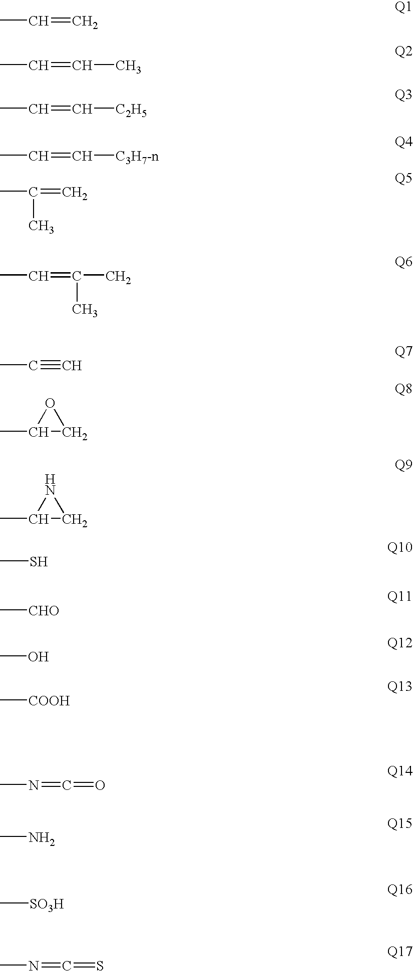

Among the aforementioned polymerizable groups, there is more preferred an unsaturated polymerizable group (Q1-Q7), an epoxy group (Q8) or an aziridinyl group (Q9), further preferably an unsaturated polymerizable group (Q1-Q7) and most preferably an ethylenic unsaturated polymerizable group (Q1-Q6).

The liquid crystal compound capable of expressing a rod-shape liquid crystal phase is not particularly restricted in shape, and may have a rod-shape, a plate-shape or another shape. Among these, a plate shape is preferred in consideration of a mutual solubility with the liquid crystal compound expressing a discotic liquid crystal phase, and an ease of expression of a biaxial nematic liquid crystal phase.

A “plate shape” of the liquid crystal compound means that such compound is a monoaxial liquid crystal flat compound showing a positive birefringence and having at least two core parts which individually show a liquid crystalline property and which are mutually bonded by a covalent bond. For example, in an example compound (m-1) of the invention to be explained later, a part RO-Ph-OR (Ph: benzene ring) corresponds to a core part showing a liquid crystalline property singly. The example compound (m-1) is formed by a covalent bonding of the part RO-Ph-RO.

More specifically, a “plate shape” of the liquid crystal compound has a following meaning. Taking a circumscribed rectangular parallelopiped of a minimum volume on a stabilized structure of the liquid crystal compound, with a longest side Ll, an intermediate side Lm and a shortest side Ls, a “plate shape” of the liquid crystal compound means a situation meeting conditions of L1/Lm>1.1 and Lm/Ls>1.5. A most stable structure of the liquid crystal compound can be obtained by MOPAC (semi-empirical molecular orbit calculation program), more specifically by AMI method of MOPAC (software: WinMOPAC, available from Fujitsu Co.).

In the invention, a plate shape of the liquid crystal compound expressing a rod-shape liquid crystal phase preferably further satisfies following formulas (I) and (II):
1.2<Ll/Lm<10 formula (I)
2.0<Lm/Ls<20. formula (II)

The liquid crystal compound having a plate shape can be, for example, those described in Mol. Cry. Liq. Cry., vol. 323, p. 231(1998), “Senryo to Yakuhin”, vol. 42, No. 4, p. 85(1997) and “Senryo to Yakuhin”, vol. 42, No. 3, p. 68(1997) and described compounds in which a polymerizable group is introduced.

In the following, specific examples of the liquid crystal compound having a plate shape are shown, but the present invention is not limited to such examples.

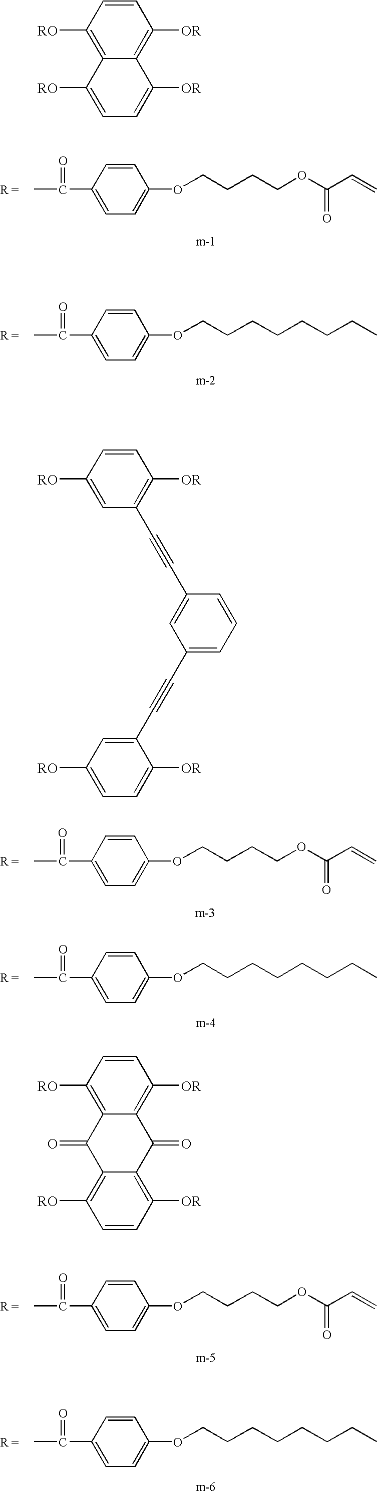

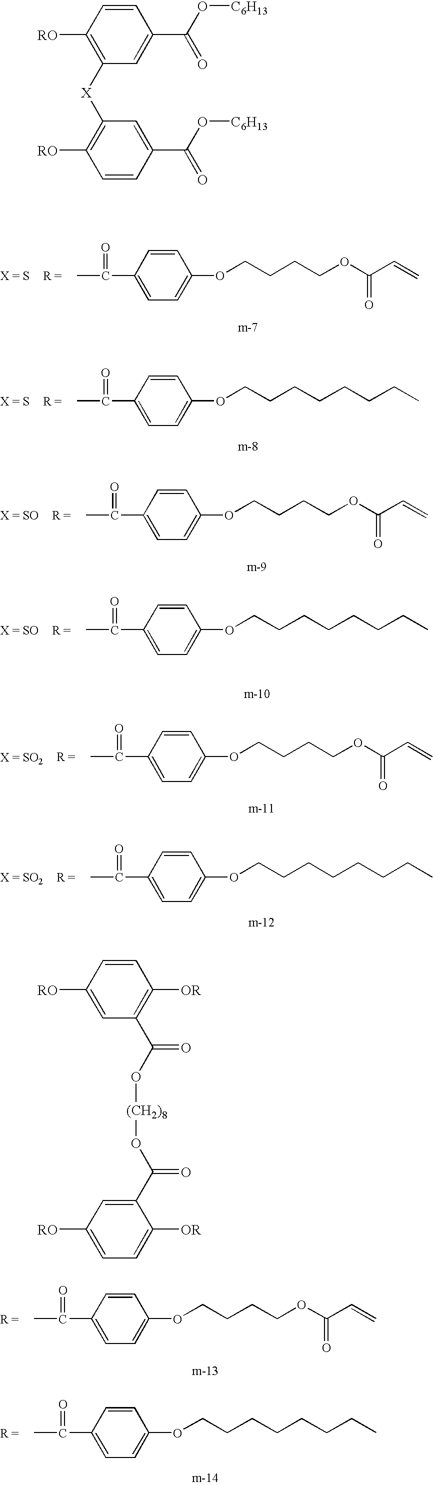

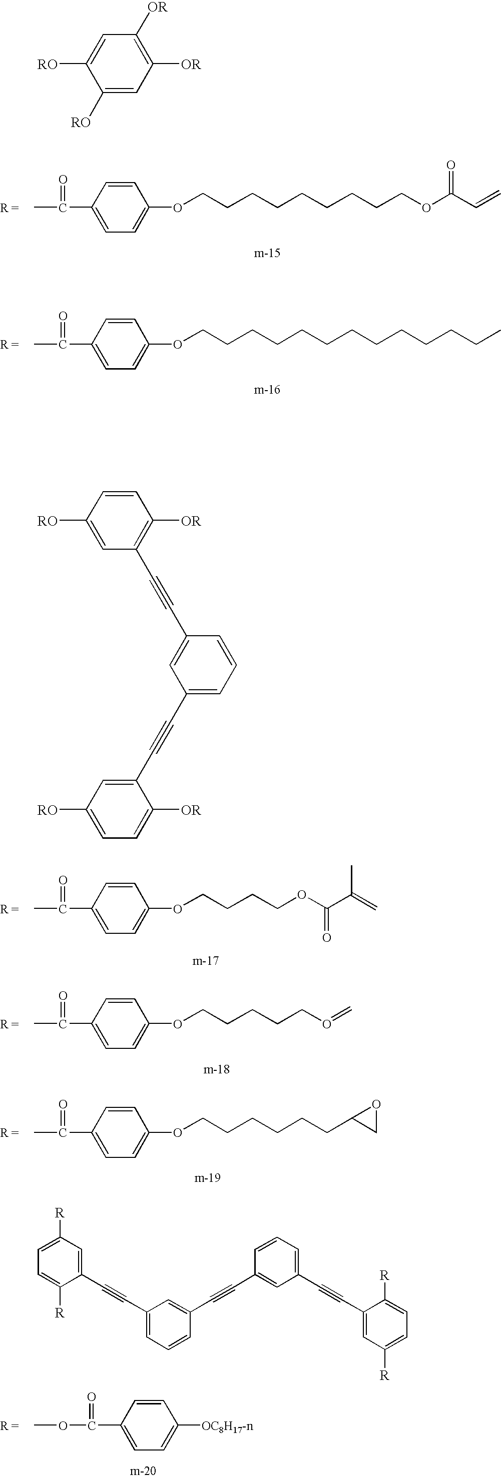

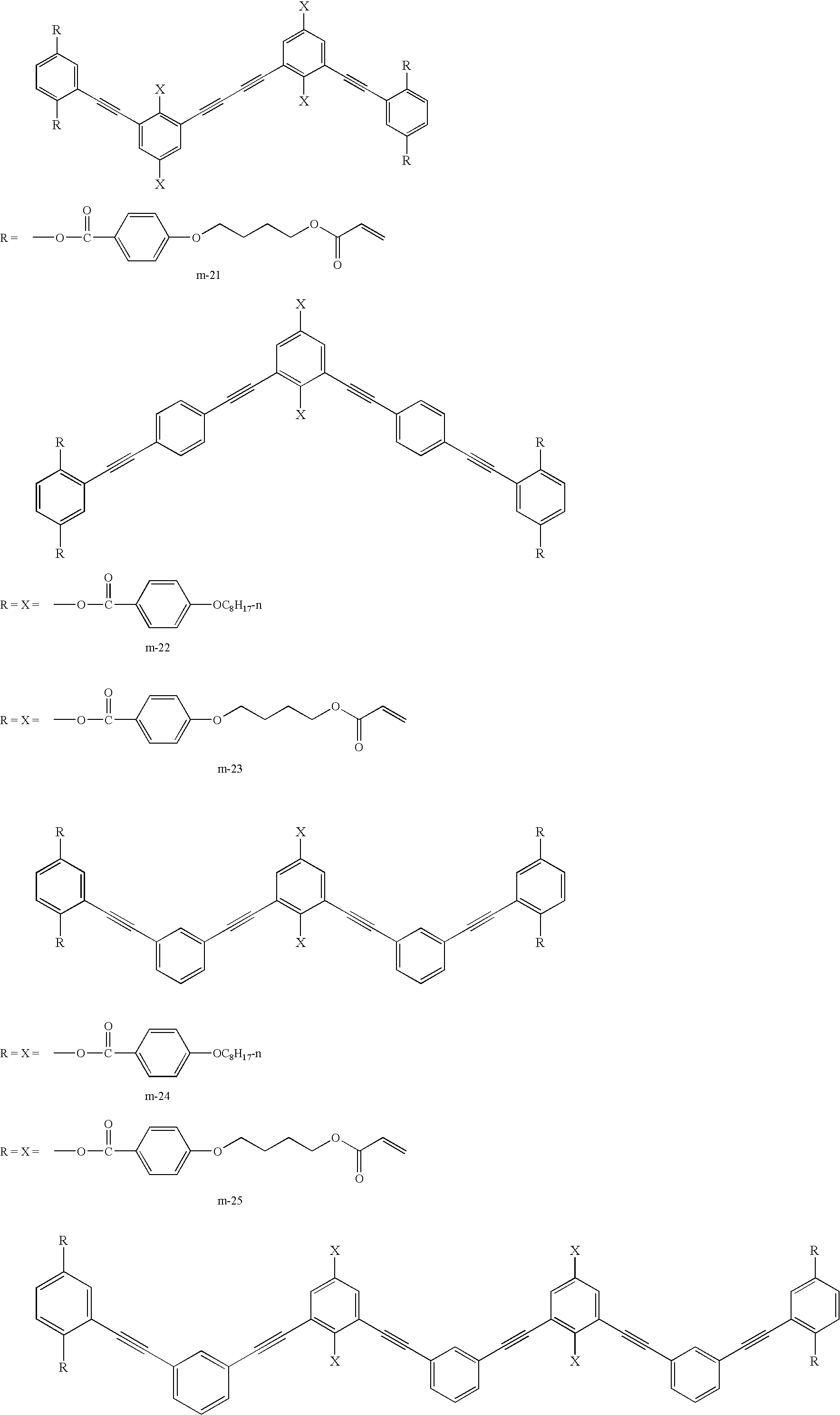

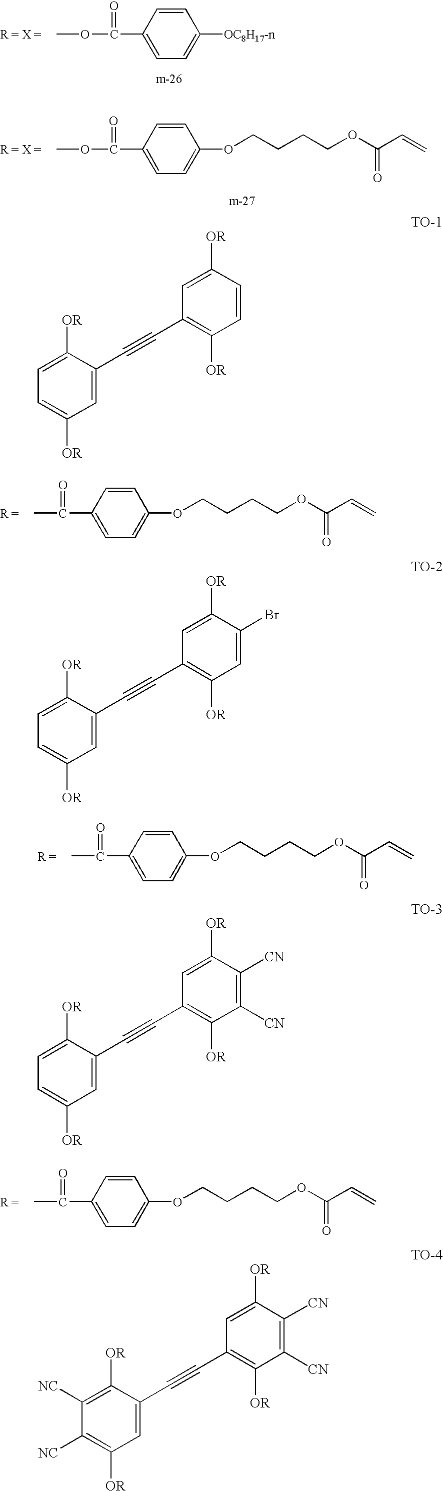

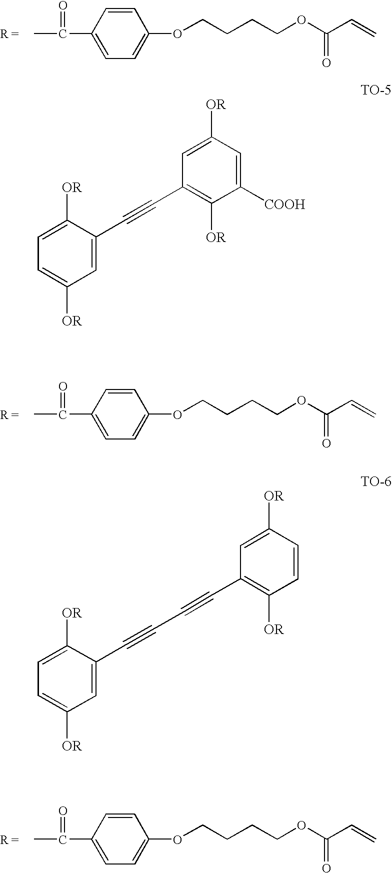

(Liquid Crystal Compound Expressing Discotic Liquid Crystal Phase)

A discotic liquid crystal phase includes a discotic nematic phase, a columnar phase, and a columnar lamellar phase, expressed by a liquid crystal compound having a disk shape. In the invention, the discotic liquid crystal phase is particularly preferably a discotic nematic phase.

On the other hand, there is also known a liquid crystal phase which is difficult to judge whether it is monoaxial or biaxial. For example, a liquid crystal phase described by D. Demus, J. Goodby et al., (Handbook of Liquid Crystals, vol. 2B: Low Molecular Weight Liquid Crystals II, pp. 933-943: Wiley-VCH) can be considered as a liquid crystal phase of difficult judgment. The liquid crystal compound expressing a rod-shape liquid crystal phase includes also such compound which is difficult to judge whether it is monoaxial or biaxial.

The liquid crystal compound expressing the discotic liquid crystal phase may be a low-molecular weight liquid crystal compound or a high-molecular weight liquid crystal compound, but is preferably a low-molecular weight liquid crystal compound in consideration of a mutual solubility of the liquid crystal compound expressing a discotic liquid crystal phase and the liquid crystal compound expressing a rod-shape liquid crystal phase.

A liquid crystal compound capable of expressing a discotic liquid crystal phase is described in known literatures (such as C. Destrade et al., Mol. Crysr. Liq. Cryst., vol. 71, page 111 (1981); The Chemical Society of Japan, Kikan Kagaku Sosetsu, No. 22, Chemistry of Liquid Crystal, chap. 5, chap. 10, para. 2(1994); B. Kohne et al., Angew. Chem. Soc. Chem. Comm., p. 1794(1985); and J. Zhang et al., J. Am. Chem. Soc., vol. 116, p. 2655(1994)).

The liquid crystal compound capable of expressing a discotic liquid crystal phase preferably has a polymerizable group, and more preferably has a polymerizable group at a terminal end of a molecule of the compound. Presence of the polymerizable group is preferred since, in addition to the prevention of a phase separation from the liquid crystal compound expressing the rod-shape liquid crystal phase as described above, it can prevent a change in a phase difference by heat or the like, in case the liquid crystal composition of the invention is employed in a retardation plate or the like. It is particularly preferably a compound represented by a following formula (D):
D(-L-Q)ₙ formula (D)
wherein D represents a disk-shaped core; L represents a divalent connecting group; Q represents a polymerizable group; and n is an integer of 3-12. In the following, structural formulas showing specific examples (D1-D15) of the formula (D) are shown, wherein LQ (or QL) means a combination of a divalent connecting group (L) and a polymerizable group (Q). A structure obtained by deleting LQ (or QL) from each example constitutes an example of the disk-shape core (D) of the foregoing formula (D).

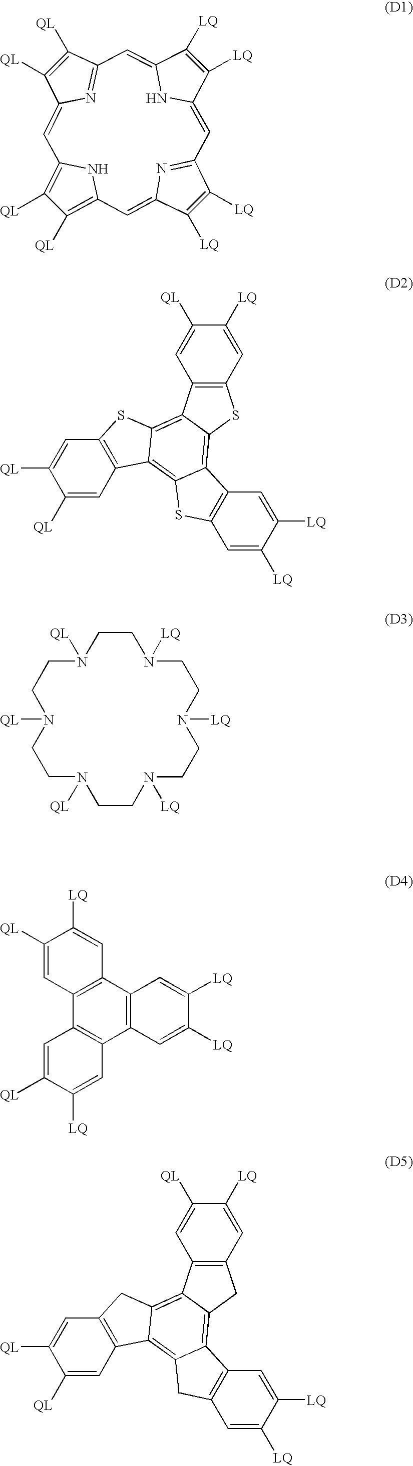

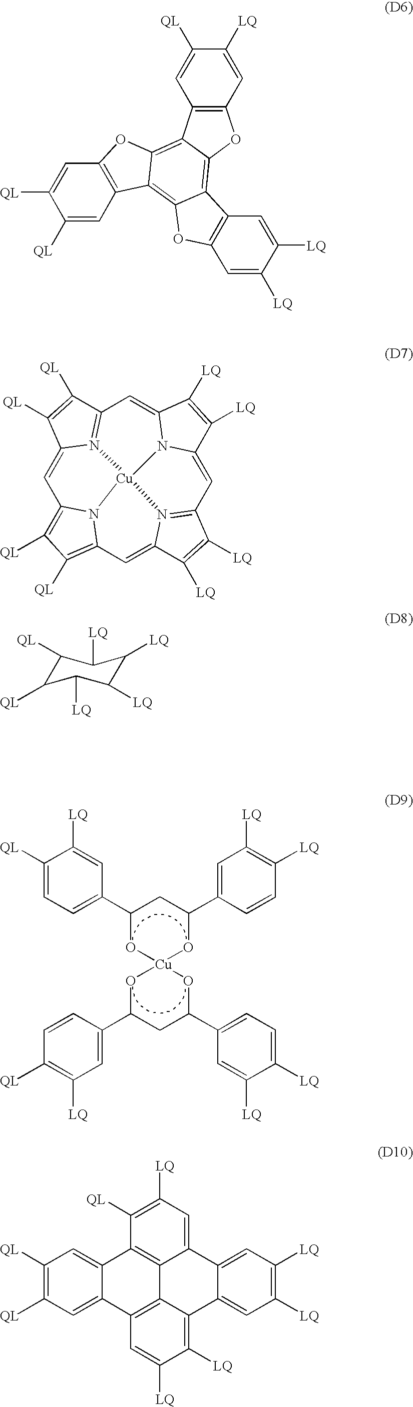

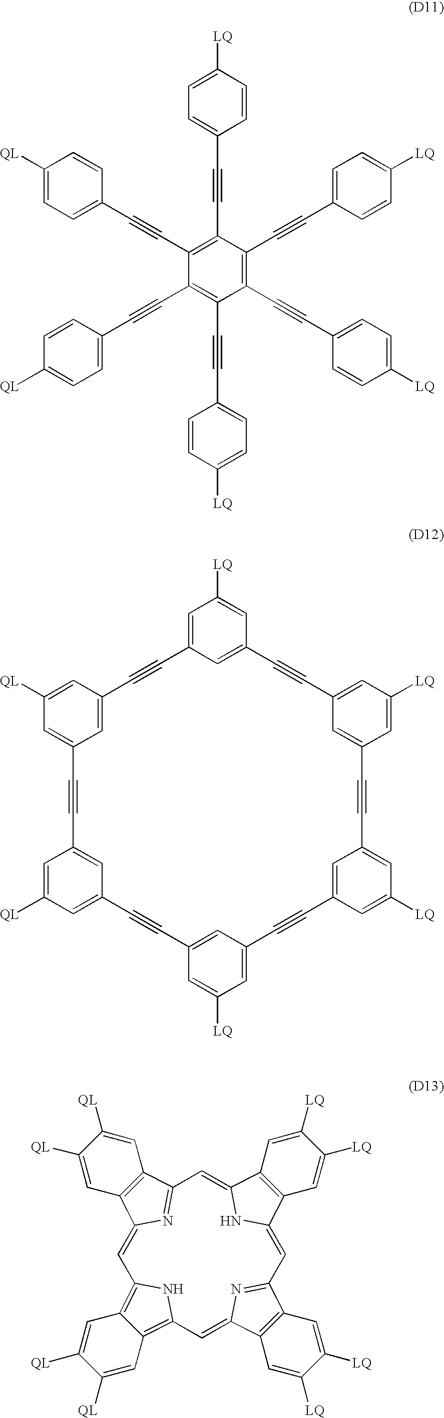

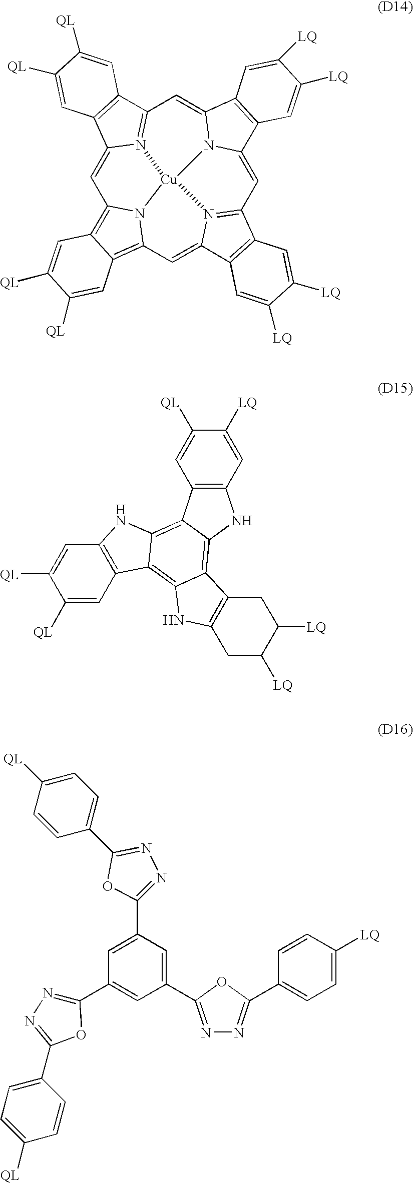

L in the formula (D) preferably represents a divalent connecting group, selected from a group of an alkylene group, an alkenylene group, an arylene group, —C(═O)—, —NH—, —O—, —S— and a combination thereof L is more preferably a group formed by combining at least two divalent group selected from a group of an alkylene group, an alkenylene group, an arylene group, —C(═O)—, —NH—, —O—, and —S—. L is most preferably a group formed by combining at least two divalent group selected from a group of an alkylene group, an alkenylene group, an arylene group, —C(═O)—, and —O—.

The alkylene group preferably has 1 to 12 carbon atoms. The alkenylene group preferably has 2 to 12 carbon atoms. The arylene group preferably has 6 to 10 carbon atoms. The alkylene group, the alkenylene group or the arylene group may have a substituent (such as an alkyl group, a halogen atom, a cyano group, an alkoxy group or an acyloxy group).

In the following there are shown examples of the divalent connecting group (L). In each formula, a left-hand side is bonded to the disk-shape core (D)) and a right-hand side is bonded to the polymerizable group (Q). AL indicates an alkylene group or an alkenylene group, and AR indicates an arylene group.
L1: -AL-C(═O)—O-AL-
L2: -AL-C(═O)—O-AL-O—
L3: -AL-C(═O)—O-AL-O-AL-
L4: -AL-C(═O)—O-AL-O—C(═O)—
L5: —C(═O)-AR-O-AL-
L6: —C(═O)-AR-O-AL-O—
L7: —C(═O)-AR-O-AL-O—C(═O)—
L8: —C(═O)—NH-AL-
L9: —NH-AL-O—
L10: —NH-AL-O—C(═O)—
L11: —O-AL-
L12: —O-AL-O—
L13: —O-AL-O—C(═O)—
L14: —O-AL-O—C(═O)—NH-AL-
L15: —O-AL-S-AL-
L16: —O—C(═O)-AL-AR-O-AL-O—C(═O)—
L17: —O—C(═O)-AR-O-AL-C(═O)—
L18: —O—C(═O)-AR-O-AL-O—C(═O)—
L19: —O—C(═O)-AR-O-AL-O-AL-O—C(═O)—
L20: —O—C(═O)-AR-O-AL-O-AL-O-AL-O—C(═O)—
L21: —S-AL-
L22: —S-AL-O—
L23: —S-AL-O—C(═O)—
L24: —S-AL-S-AL-
L25: —S-AR-AL-

In the formula (D), the polymerizable group (O) is not particularly restricted. In case of employing a polymerization in the invention, it can be determined according to the type of the polymerization reaction.

Preferred examples of the polymerizable group (Q) are similar to those for the liquid crystal compound expressing a rod-shape liquid crystal phase, and more preferred examples of the polymerizable group (Q) are similar to those for the liquid crystal compound expressing a rod-shape liquid crystal phase.

In the formula (D), n represents an integer from 3 to 12. A specific number is determined according to the type of the disk-shaped core (D). n is preferably an integer from 3 to 6, and most preferably 3. Combinations of plural L and Q may be mutually different, but are preferably same.

As the compound having the disk shape, there may be employed discotic liquid crystal compounds of two or more kinds in combination. For example, there may be employed, in combination, a molecule having a polymerizable group (Q) and a molecule not having such group.

A non-polymerizable discotic liquid crystal compound is preferably a compound obtained by replacing a polymerizable group (Q) in the aforementioned polymerizable discotic liquid crystal compound, with a hydrogen atom or an alkyl group. Thus, the non-polymerizable discotic liquid crystal compound is preferably a compound represented by a following formula:
D(-L-R)ₙ
wherein D represents a disk-shaped core; L represents a divalent connecting group; R represents a hydrogen atom or an alkyl group; and n is an integer of 3-12. Examples of the disk-shaped core (D) in the foregoing formula are same as those for the polymerizable discotic liquid crystal compound except that LQ (or QL) is replaced by LR (or RL). Also the examples of the divalent connecting group (L) are similar to those in the aforementioned polymerizable discotic liquid crystal compound. The alkyl group R preferably has 1 to 40 carbon atoms, and more preferably 1 to 30 carbon atoms. A linear alkyl group is preferable to a cyclic alkyl group, and a straight-chain alkyl group is preferable to a branched linear alkyl group. R is particularly preferably a hydrogen atom or a straight-chain alkyl group with 1 to 30 carbon atoms.

A liquid crystal compound expressing a discotic liquid crystal phase to be employed in the invention is most preferably represented by a following formula (I):

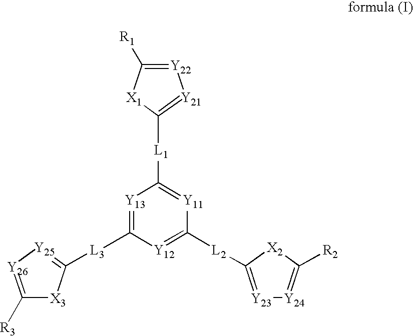

In the formula (I), Y₁₁, Y₁₂, Y₁₃, Y₂₁, Y₂₂, Y₂₃, Y₂₄, Y₂₅, and Y₂₆ each independently represents a methine or a nitrogen atom.

In case any of Y₁₁, Y₁₂, Y₁₃, Y₂₁, Y₂₂, Y₂₃, Y₂₄, Y₂₅, and Y₂₆ represents a methine, it may have a substituent. Examples of the substituent include an alkyl group (such as a methyl group, an ethyl group, an isopropyl group, or a tert-butyl group), an alkenyl group (such as a vinyl group, an allyl group, a 2-butenyl group, or a 3-pentenyl group), an alkinyl group (such as a propalgyl group, or a 3-pentinyl group), an aryl group (such as a phenyl group, a p-methylphenyl group or a naphthyl group), a substituted or non-substituted amino group (such as a non-substituted amino group, a methylamino group, a dimethylamino group, a diethylamino group or an anilino group), an alkoxy group (such as a methoxy group, an ethoxy group or a butoxy group), an aryloxy group (such as a phenyloxy group or a 2-naphthyloxy group), an acyl group (such as an acetyl group, a benzoyl group, a formyl group, or a pivaloyl group), an alkoxycarbonyl group (such as a methoxycarbonyl group or an ethoxycarbonyl group), an aryloxycarbonyl group (such as phenoxycarbonyl), an acyloxy group (such as an acetoxy group, or a benzoyloxy group), an acylamino group (such as an acetylamino group or a benzoylaminogroup), an alkoxycarbonylamino group (such as a methoxycarbonylamino group), an aryloxycarbonylamino group (such as a phenyloxycarbonylamino group), an alkylsulfonylamino group (such as a methanesulfonylamino group), an arylsulfonylamino group (such as a benzenesulfonylamino group), a sulfamoyl group (such as a sulfamoyl group, (such as a sulfamoyl group, an N-methylsulfamoyl group, an N,N-dimethylsulfamoyl group or an N-phenylsulfamoyl group), a carbamoyl group (such as a non-substituted carbamoyl group, an N-methylcarbamoyl group, a N,N-diethylcarbamoyl group or an N-phenylcarbamoyl group), an alkylthio group (such as a methylthio group, or an ethylthio group), an arylthio group (such as a phenylthio group), an alkylsulfonyl group (such as a mesyl group), an arylsulfonyl group (such as a tosyl group), an alkylsulfinyl group (such as a methanesulfinyl group), an arylsulfinyl group (such as a benzenesulfinyl group), an ureido group (such as a non-substituted ureido group, a 3-methylureido group or a 3-phenylureido group), a phosphatamide group (such as a diethylphosphatamide group, or a phenylphosphatamide group), a hydroxyl group, a mercapto group, a halogen atom (such as a fluorine atom, a chlorine atom, a bromine atom or an iodine atom), a cyano group, a sulfo group, a carboxyl group, a nitro group, a hydroxamic acid group, a sulfino group, a hydrazino group, an imino group, a heterocyclic group (a heterocyclic group having a hetero atom such as a nitrogen atom, an oxygen atom or a sulfur atom, such as an imidazolyl group, a pyridyl group, a quinolyl group, a furyl group, a piperidyl group, a morpholino group, a benzoxazolyl group, a benzimidazolyl group, or a benzothiazolyl group), and a silyl group (such as a trimethylsilyl group or a triphenylsilyl group). Such substituent may be substituted further with these substituents.

Among these, the substituent for methine is preferably an alkyl group, an alkoxy group, an aryloxy group, an acyl group, an alkoxycarbonyl group, an acyloxy group, an acylamino group, an alkoxycarbonylamino group, an alkylthio group, an arylthio group, a halogen atom or a cyano group, more preferably an alkyl group, an alkoxy group, an alkoxycarbonyl group, an acyloxy group, a halogen atom or a cyano group, and most preferably an alkyl group with 1 to 12 carbon atoms, an alkoxy group with 1 to 12 carbon atoms, an alkoxycarbonyl group with 2 to 12 carbon atoms, an acyloxy group with 2 to 12 carbon atoms, a halogen atom or a cyano group.

In the formula (I), X₁, X₂ and X₃ each independently represents an oxygen atom, a sulfur atom, a methylene or an imino. In case each of X₁, X₂ and X₃ represents methylene or imino, it may have a substituent. The substituent is preferably those cited above as the substituent for methine. Such substituent may further have a substituent, which can be those cited above as the substituent that the substituent of methine may have.

In the formula (I), L₁, L₂ and L₃ each independently represents a single bond or a divalent connecting group. In case any of L₁, L₂ and L₃ represents a divalent connecting group, it is preferably a divalent connecting group selected from a group of —O—, —S—, —C(═O)—, —NR₇—, —CH═CH—, —C≡C—, a divalent cyclic group and a combination thereof, wherein R₇ is an alkyl group with 1 to 7 carbon atoms or a hydrogen atom, preferably an alkyl group with 1 to 4 carbon atoms or a hydrogen atom, more preferably a methyl group, an ethyl group or a hydrogen atom, and most preferably a hydrogen atom.

A divalent cyclic group represented by L₁, L₂ or L₃ is a divalent connecting group having at least a cyclic structure. The divalent cyclic group is preferably a 5-, 6- or 7-membered ring, more preferably a 5-, or 6-membered ring, and most preferably a 6-membered ring. A ring contained in the cyclic group may be condensed rings, but a single ring is more preferred to condensed rings. Also a ring contained in the cyclic group may be an aromatic ring, an aliphatic ring or a heterocycle. Examples of the aromatic ring include a benzene ring and a naphthalene ring. Examples of the aliphatic ring include a cyclohexane ring. Also examples of the heterocycle includes a pyridine ring and a pyrimidine ring. The cyclic group is preferably an aromatic ring or a heterocycle.

Among the divalent cyclic group represented by L₁, L₂ or L₃, a divalent cyclic group having a benzene ring is preferably 1,4-phenylene. A divalent cyclic group having a naphthalene ring is preferably naphthalene-1,5-diyl or naphthalene-2,6-diyl. A cyclic group having a cyclohexane ring is preferably 1,4-cyclohexylene. A cyclic group having a pyridine ring is preferably pyridine-2,5-diyl. A cyclic group having a pyrimidine ring is preferably pyrimidine-2,5-diyl.

A divalent cyclic group represented by L₁, L₂ or L₃ may have a substituent. Examples of the substituent include a halogen atom, a cyano group, a nitro group, an alkyl group with 1 to 16 carbon atoms, a halogen-substituted alkyl group with 1 to 16 carbon atoms, an alkoxy group with 1 to 16 carbon atoms, an acyl group with 2 to 16 carbon atoms, an alkylthio group with 1 to 16 carbon atoms, an acyloxy group with 2 to 16 carbon atoms, an alkoxycarbonyl group with 2 to 16 carbon atoms, a carbamoyl group, an alkyl-substituted carbamoyl group with 2 to 16 carbon atoms, and an acylamino group with 2 to 16 carbon atoms.

L₁, L₂ and L₃ each is preferably a single bond, *—O—CO—, *—CH═CH—, *—C≡C—, *-(divalent cyclic group)-, *—O—CO-(divalent cyclic group)-, *—CO—O-(divalent cyclic group)-, *—CH═CH-(divalent cyclic group)-, *—C≡C-(divalent cyclic group)-, *-(divalent cyclic group)-O—CO—, *-(divalent cyclic group)-CO—O—, *-(divalent cyclic group)-CH═CH—, or *-(divalent cyclic group)-C≡C—, and particularly preferably a single bond, *—CH═CH—, *—C═C—, *—CH═CH-(divalent cyclic group)-, or *—C≡C-(divalent cyclic group)-, wherein * indicates a bonding position to the 6-membered ring containing Y₁₁, Y₁₂ and Y₁₃ in the formula (I).

In the formula (I), R₁, R₂ and R₃ each independently represents an alkyl group (such as a methyl group, an ethyl group, an isopropyl group, or a tert-butyl group), an alkenyl group (such as a vinyl group, an allyl group, a 2-butenyl group, or a 3-pentenyl group), an alkinyl group (such as a propalgyl group, or a 3-pentinyl group), an aryl group (such as a phenyl group, a p-methylphenyl group or a naphthyl group), a substituted or non-substituted amino group (such as a non-substituted amino group, a methylamino group, a dimethylamino group, a diethylamino group or an anilino group), an alkoxy group (such as a methoxy group, an ethoxy group or a butoxy group), an aryloxy group (such as a phenyloxy group or a 2-naphthyloxy group), an acyl group (such as an acetyl group, a benzoyl group, a formyl group, or a pivaloyl group), an alkoxycarbonyl group (such as a methoxycarbonyl group or an ethoxycarbonyl group), an aryloxycarbonyl group (such as phenoxycarbonyl), an acyloxy group (such as an acetoxy group, or a benzoyloxy group), an acylamino group (such as an acetylamino group or a benzoylaminogroup), an alkoxycarbonylamino group (such as a methoxycarbonylamino group), an aryloxycarbonylamino group (such as a phenyloxycarbonylamino group), an alkylsulfonylamino group (such as a methanesulfonylamino group), an arylsulfonylamino group (such as a benzenesulfonylamino group), a sulfamoyl group (such as a sulfamoyl group, (such as a sulfamoyl group, an N-methylsulfamoyl group, an N,N-dimethylsulfamoyl group or an N-phenylsulfamoyl group), a carbamoyl group (such as a non-substituted carbamoyl group, an N-methylcarbamoyl group, a N,N-diethylcarbamoyl group or an N-phenylcarbamoyl group), an alkylthio group (such as a methylthio group, or an ethylthio group), an arylthio group (such as a phenylthio group), an alkylsulfonyl group (such as a mesyl group), an arylsulfonyl group (such as a tosyl group), an alkylsulfinyl group (such as a methanesulfinyl group), an arylsulfinyl group (such as a benzenesulfinyl group), an ureido group (such as a non-substituted ureido group, a 3-methylureido group or a 3-phenylureido group), a phosphatamide group (such as a diethylphosphatamide group, or a phenylphosphatamide group), a hydroxyl group, a mercapto group, a halogen atom (such as a fluorine atom, a chlorine atom, a bromine atom or an iodine atom), a cyano group, a sulfo group, a carboxyl group, a nitro group, a hydroxamic acid group, a sulfino group, a hydrazino group, an imino group, a heterocyclic group (a heterocyclic group having a hetero atom such as a nitrogen atom, an oxygen atom or a sulfur atom, such as an imidazolyl group, a pyridyl group, a quinolyl group, a furyl group, a piperidyl group, a morpholino group, a benzoxazolyl group, a benzimidazolyl group, or a benzothiazolyl group), or a silyl group (such as a trimethylsilyl group or a triphenylsilyl group). Such substituent may be substituted further with these substituents.

R₁, R₂ and R₃ each independently is represented more preferably by a following formula (III):
*-L₁₁-Q formula (III)

In the formula (III), * indicates a bonding position to the 5-membered ring in the formula (I).

Q each independently represents a polymerizable group or a methyl group. In case of utilizing the compound of the formula (I) in an optical compensation film, including a retardation plate of the invention, in which a magnitude of a phase difference is preferably not affected by heat, Q is preferably a polymerizable group. The polymerization reaction is preferably an addition polymerization (including a ring-opening polymerization) or a condensation polymerization. Stated differently, the polymerizable group is preferably a functional group capable of an addition polymerization reaction or a condensation polymerization reaction. Examples of the polymerizable group are shown in the following.

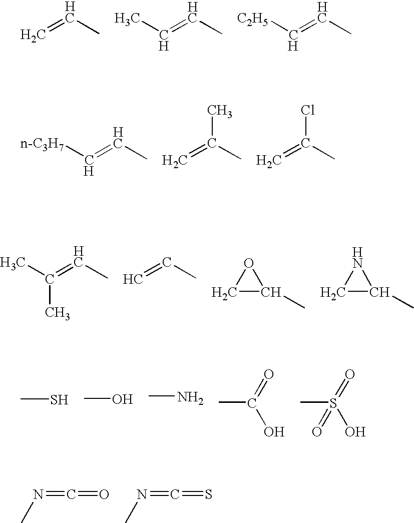

The polymerizable group is particularly preferably a functional group capable of an addition polymerization reaction. Such polymerizable group is preferably an ethylenic polymerizable unsaturated group or a ring-opening polymerizable group.

Examples of the ethylenic polymerizable unsaturated group include following (M-1) to (M-6).

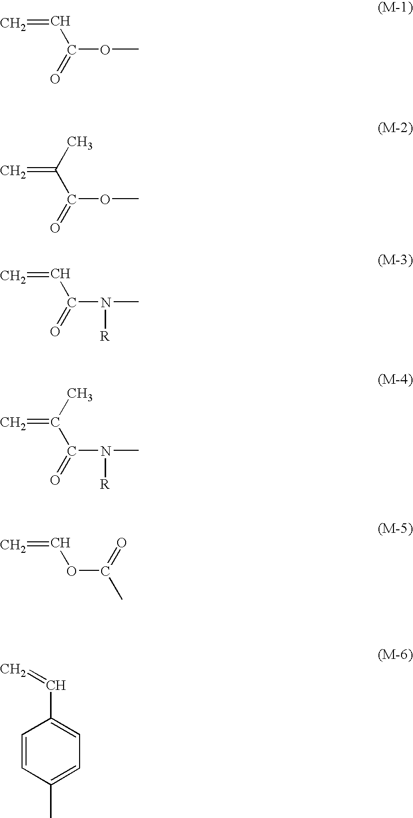

In the formula (M-3) and (M-4), R represents a hydrogen atom or an alkyl group, and is preferably a hydrogen atom or a methyl group.

Among the formulas (M-1) to (M-6), (M-1) or (M-2) is preferably, and (M-1) is most preferable.

A ring-opening polymerizable group is preferably a cyclic ether group, among which an epoxy group or an oxetanyl group is more preferable and an epoxy group is most preferable.

In the formula (III), L1, represents a divalent connecting group, preferably selected from a group of —O—, —S—, —C(═O)—, —NR₇—, a divalent linear group, a divalent cyclic group and a combination thereof, wherein R₇ is an alkyl group with 1 to 7 carbon atoms or a hydrogen atom, preferably an alkyl group with 1 to 4 carbon atoms or a hydrogen atom, more preferably a methyl group, an ethyl group or a hydrogen atom, and most preferably a hydrogen atom.

A divalent linear group represented by L₁₁, can be an alkylene group, a substituted alkylene group, an alkenylene group, a substituted alkenylene group, an alkinylene group, or a substituted alkinylene group. Among these, there is preferred an alkylene group, a substituted alkylene group, an alkenylene group, or a substituted alkenylene group, and more preferably an alkylene group or an alkenylene group.

An alkylene group as the divalent linear group represented by L₁₁, may have a branched structure. The alkylene group preferably has 1 to 16 carbon atoms, more preferably 2 to 14 carbon atoms, and most preferably 2 to 12 carbon atoms. An alkylene portion of the substituted alkylene group is similar to the alkylene group mentioned above. Examples of the substituent include a halogen atom.

An alkenylene group as the divalent linear group represented by L₁₁, may have a substituted or non-substituted alkylene group in a main chain, and may have a branched structure. The alkenylene group preferably has 2 to 16 carbon atoms, more preferably 2 to 14 carbon atoms, and most preferably 2 to 12 carbon atoms. An alkenylene portion of the substituted alkenylene group is similar to the alkenylene group mentioned above. Examples of the substituent include a halogen atom.

An alkinylene group as the divalent linear group represented by L₁₁ may have a substituted or non-substituted alkylene group in a main chain, and preferably has 2 to 16 carbon atoms, more preferably 2 to 14 carbon atoms, and most preferably 2 to 12 carbon atoms. An alkinylene portion of the substituted alkinylene group is similar to the alkinylene group mentioned above. Examples of the substituent include a halogen atom.

Specific examples of the divalent linear group represented by L₁₁, include ethylene, trimethylene, tetramethylene, 1-methyl-1,4-butylene, pentamethylene, hexamethylene, octamethylene, nonamethylene, decamethylene, undecamethylene, dodecamethylene, 2-butenylene and 2-butinylene.

A divalent cyclic group represented by L₁₁, is a divalent connecting group having at least a cyclic structure. The divalent cyclic group is preferably a 5-, 6- or 7-membered ring, more preferably a 5-, or 6-membered ring, and most preferably a 6-membered ring. A ring contained in the cyclic group may be condensed rings, but a single ring is more preferred to condensed rings. Also a ring contained in the cyclic group may be an aromatic ring, an aliphatic ring or a heterocycle. Examples of the aromatic ring include a benzene ring and a naphthalene ring. Examples of the aliphatic ring include a cyclohexane ring. Also examples of the heterocycle includes a pyridine ring and a pyrimidine ring.

Among the divalent cyclic group represented by L₁₁, a divalent cyclic group having a benzene ring is preferably 1,4-phenylene. A divalent cyclic group having a naphthalene ring is preferably naphthalene-1,5-diyl or naphthalene-2,6-diyl. A cyclic group having a cyclohexane ring is preferably 1,4-cyclohexylene. A cyclic group having a pyridine ring is preferably pyridine-2,5-diyl. A cyclic group having a pyrimidine ring is preferably pyrimidine-2,5-diyl.

A divalent cyclic group represented by L₁₁, may have a substituent. Examples of the substituent include a halogen atom, a cyano group, a nitro group, an alkyl group with 1 to 16 carbon atoms, a halogen-substituted alkyl group with 1 to 16 carbon atoms, an alkoxy group with 1 to 16 carbon atoms, an acyl group with 2 to 16 carbon atoms, an alkylthio group with 1 to 16 carbon atoms, an acyloxy group with 2 to 16 carbon atoms, an alkoxycarbonyl group with 2 to 16 carbon atoms, a carbamoyl group, an alkyl-substituted carbamoyl group with 2 to 16 carbon atoms, and an acylamino group with 2 to 16 carbon atoms.

R₁, R₂ and R₃ each independently is represented further preferably by a following formula (IV):
formula (IV): *-L₂₁-(divalent connecting group)-Q₁

In the formula (IV), * indicates a bonding position to the 5-membered ring in the formula (I).

Q₁ has a definition same as that for Q in the formula (III).

L₂₁ represents a single bond or a divalent connecting group. In case L₂₁ represents a divalent connecting group, it is preferably a divalent connecting group selected from a group of —O—, —S—, —C(═O)—, —NR₇—, —CH═CH—, —C≡C—, and a combination thereof, wherein R₇ is an alkyl group with 1 to 7 carbon atoms or a hydrogen atom, preferably an alkyl group with 1 to 4 carbon atoms or a hydrogen atom, more preferably a methyl group, an ethyl group or a hydrogen atom, and most preferably a hydrogen atom.

L₂₁ is preferably a single bond, *—O—CO—, *—CO—O—, *—CH═CH—, or *—C═C—(wherein * indicates a side of * in the formula (IV).

In the formula (IV), a divalent cyclic group has a same definition as the divalent cyclic group in the formula (III).

In the formula (IV), L₂₂ has a same definition as that for L₁, in the formula (III).

Examples of the divalent connecting group represented by L₂₂ are shown in the following, wherein a right-hand side is bonded to the divalent cyclic group in the formula (IV) and a left-hand side is bonded to Q1.

(0117)

L-1: -(divalent linear group)-O-(divalent cyclic group)-
L-2: -(divalent linear group)-O-(divalent cyclic group)-CO—O—
L-3: -(divalent linear group)-O-(divalent cyclic group)-O—CO—
L-4: -(divalent linear group)-O-(divalent cyclic group)-CO—NR₇—
L-5: -(divalent linear group)-O-(divalent cyclic group)-(divalent linear group)-
L-6: -(divalent linear group)-O-(divalent cyclic group)- (divalent linear group)-CO—O—
L-7: -(divalent linear group)-O-(divalent cyclic group)- (divalent linear group)-O—CO—
L-8: -(divalent linear group)-O—CO-(divalent cyclic group)-
L-9: -(divalent linear group)-O—CO-(divalent cyclic group)-CO—O—
L-10: -(divalent linear group)-O—CO-(divalent cyclic group)-O—CO—
L-11: -(divalent linear group)-O—CO-(divalent cyclic group)-CO—NR₇—
L-12: -(divalent linear group)-O—CO-(divalent cyclic group)-(divalent linear group)-
L-13: -(divalent linear group)-O—CO-(divalent cyclic group)- (divalent linear group)-CO—O—
L-14: -(divalent linear group)-O—CO-(divalent cyclic group)- (divalent linear group)-O—CO—
L-15: -(divalent linear group)-CO—O-(divalent cyclic group)-
L-16: -(divalent linear group)-CO—O-(divalent cyclic group)-CO—O—
L-17: -(divalent linear group)-CO—O-(divalent cyclic group)-O—CO—
L-18: -(divalent linear group)-CO—O-(divalent cyclic group)-CO—NR₇—
L-19: -(divalent linear group)-CO—O-(divalent cyclic group)-(divalent linear group)-
L-20: -(divalent linear group)-CO—O-(divalent cyclic group)- (divalent linear group)-CO—O—
L-21: -(divalent linear group)-CO—O-(divalent cyclic group)- (divalent linear group)-O—CO—
L-22: -(divalent linear group)-O—CO—O-(divalent cyclic group)-
L-23: -(divalent linear group)-O—CO—O-(divalent cyclic group)-CO—O—
L-24: -(divalent linear group)-O—CO—O-(divalent cyclic group)-O—CO—
L-25: -(divalent linear group)-O—CO—O-(divalent cyclic group)-CO—NR₇—
L-26: -(divalent linear group)-O—CO—O-(divalent cyclic group)- (divalent linear group)-
L-27: -(divalent linear group)-O—CO—O-(divalent cyclic group)- (divalent linear group)-CO—O—
L-28: -(divalent linear group)-O—CO—O-(divalent cyclic group)- (divalent linear group)-O—CO—
L-29: -(divalent linear group)-
L-30: -(divalent linear group)-O—
L-31: -(divalent linear group)-CO—O—
L-32: -(divalent linear group)-O—CO—
L-33: -(divalent linear group)-CO—NR₇—
L-34: -(divalent linear group)-O-(divalent linear group)-
L-35: -(divalent linear group)-O-(divalent linear group)-O—
L-36: -(divalent linear group)-O-(divalent linear group)-CO—O—
L-37: -(divalent linear group)-O-(divalent linear group)-O—CO—.

Among these, there are preferred L-2, L-3, L-9, L-10, L-16, L-17, L-23, L-24, L-30, L-31, L-32, L-35, L-36, and L-37.

R₁, R₂ and R₃ each independently is represented most preferably by a following formula (V):

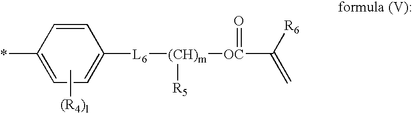

In the formula (V), * indicates a bonding position to the 5-membered ring in the formula (I).

R₄ each independently represents a halogen atom (preferably a fluorine atom, a chlorine atom, a bromine atom or an iodine atom), an alkyl group with 1 to 8 carbon atoms, an alkyloxy group with 1 to 8 carbon atoms, an acyl group with 2 to 8 carbon atoms, an acyloxy group with 2 to 8 carbon atoms, an alkoxycarbonyl group with 2 to 8 carbon atoms, a nitro group or a cyano group, and preferably a halogen atom, an alkyl group with 1 to 3 carbon atom, an alkyloxy group with 1 to 3 carbon atoms, an acyl group with 2 to 4 carbon atoms, an acyloxy group with 2 to 4 carbon atoms, an alkoxycarbonyl group with 2 to 4 carbon atoms, or a cyano group.

l indicates an integer of 0-4, preferably 0 or 1, and most preferably 0. In case l is 2 or larger, groups represented by plural R4s may be mutually different.

L₆ represents **—O—, **—CO—O—, **—O—CO—, **—O—CO—O—, or **—CH₂—, wherein ** indicates a bonding position to the benzene ring in the formula (V).

R₅ represents a hydrogen atom, a methyl group, an ethyl group, or a propyl group, more preferably a hydrogen atom or a methyl group and most preferably a hydrogen atom.

m represents an integer of 2 to 16, preferably 2 to 12.

R₆ represents a hydrogen atom or a methyl group, preferably a hydrogen atom.

In the invention, among the compounds represented by the formula (I), there is preferred a compound in which R₁, R₂ and R₃ each independently is represented by the formula (V).

A liquid crystal phase expressed by the compound represented by the formula (I) or a liquid crystal composition containing such compound is preferably a columnar phase or a discotic nematic phase, and particularly preferably a discotic nematic phase. There is preferred a liquid crystal phase that is expressed within a range of 30 to 300° C., more preferably 50 to 250° C.

A compound represented by the formula (I) but not showing a discotic liquid crystalline property can also be employed by mixing with a compound showing a discotic liquid crystal phase.

In the following, specific examples of the compound represented by the formula (I) are shown, but the present invention is not limited to such examples.

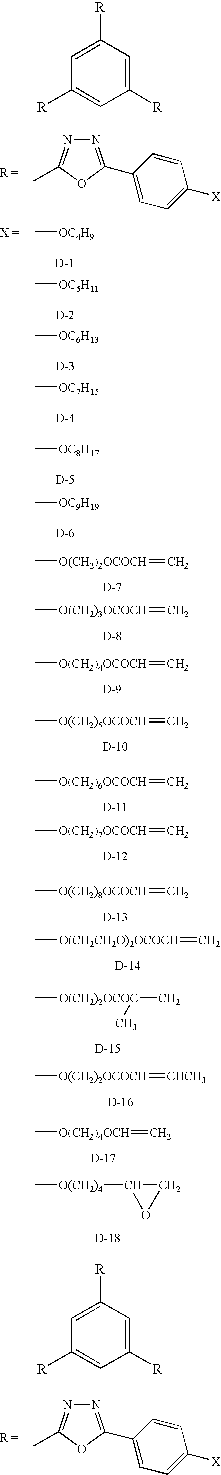

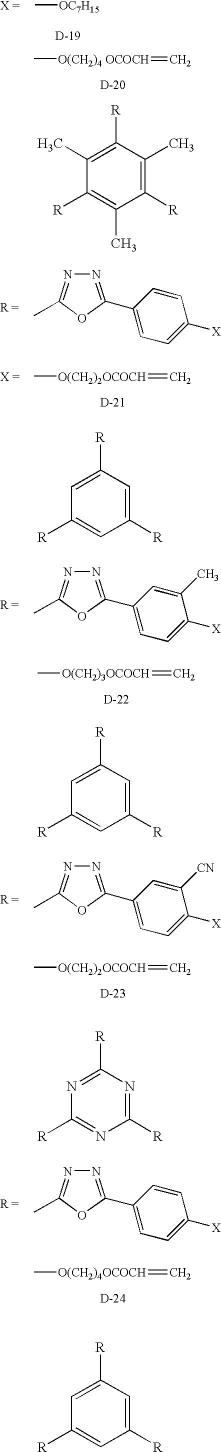

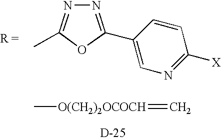

(Liquid Crystal Composition Expressing Biaxial Nematic Phase, Containing Liquid Crystal Compound Expressing Rod-Shaped Liquid Crystal Phase and Liquid Crystal Compound Expressing Discotic Liquid Crystal Phase)

A liquid crystal composition of the invention, containing a liquid crystal compound expressing a rod-shaped liquid crystal phase and a liquid crystal compound expressing a discotic liquid crystal phase, preferably expresses a biaxial nematic phase within a range of 20-300° C., more preferably 40-280° C., and most preferably 60-250° C. An expression of the liquid crystal phase within the range of 20-300° C. includes also a case where a temperature range of the liquid crystal extends across 20° C. (for example from 10 to 22° C.), or a case where a temperature range of the liquid crystal extends across 300° C. (for example from 298 to 310° C.). The same applies to the ranges of 40-280° C. and 60-250° C.

In the liquid crystal composition of the invention, containing a liquid crystal compound expressing a rod-shaped liquid crystal phase and a liquid crystal compound expressing a discotic liquid crystal phase, a mixing ratio of the liquid crystal compound expressing a rod-shaped liquid crystal phase and the liquid crystal compound expressing a discotic liquid crystal phase for expressing a biaxial nematic phase cannot be clearly defined as it is variable depending on a molecular structure and a molecular weight, but the mass ratio (weight ratio) of (liquid crystal compound expressing a rod-shaped liquid crystal phase)/(liquid crystal compound expressing a discotic liquid crystal phase) is preferably 10 to 0.02, more preferably 5 to 0.05 and most preferably 2 to 0.1.

The biaxial nematic phase is often expressed at a temperature lower than that of a monoaxial liquid crystal phase. For example, a monoaxial liquid crystal phase (such as a nematic phase or a discotic nematic phase) often shifts to a biaxial nematic phase by a temperature decrease. In many cases, when a content of the liquid crystal compound expressing the rod-shaped liquid crystal phase becomes somewhat larger than a certain mixing ratio ((liquid crystal compound expressing a rod-shaped liquid crystal phase)/(liquid crystal compound expressing a discotic liquid crystal phase)), a shift takes place from the nematic phase to the biaxial nematic phase at a temperature decrease. Also when a content of the liquid crystal compound expressing the discotic liquid crystal phase becomes somewhat larger, a shift takes place from the discotic nematic phase to the biaxial nematic phase.

In a liquid crystal composition of the present invention containing a liquid crystal compound expressing a rod-shaped liquid crystal phase and a liquid crystal compound expressing a discotic liquid crystal phase, when a monoaxial nematic phase is present at a higher temperature side of a biaxial nematic phase, a value (nx−nz)/(nx−ny) can be controlled in the biaxial liquid crystal phase.

For example, when the temperature is lowered from a nematic phase ((nx−nz)/(nx−ny)=1.0), the value (nx−nz)/(nx−ny) does not show an abrupt change but tends to gradually increase according to the temperature. It is therefore possible to control the value (nx−nz)/(nx−ny) by selecting a temperature for alignment fixation for example by a polymerization by a UV irradiation. A control range of the value (nx−nz)/(nx−ny) in case of a shift from a nematic phase to a biaxial nematic phase cannot be defined uniquely as it is variable depending on the molecular structures of the liquid crystal compound expressing a rod-shaped liquid crystal phase and the liquid crystal compound expressing a discotic liquid crystal phase, but an easy control is possible in a range closer to 1.0, and more specifically an easy control is possible in a range of 1.0<(nx−nz)/(nx−ny)<10.

Also in case of a shift from a discotic nematic phase to a biaxial nematic phase, a control on the value (nx−nz)/(nx−ny) is possible as in the case of a shift from the nematic phase, but, since the value (nx−nz)/(nx−ny) in the discotic nematic phase is infinitely large (nx=ny), an easy control is possible in a range closer to infinity, and more specifically an easy control is possible in a range of 1.2<(nx−nz)/(nx−ny)<∞.

The optically anisotropic layer is prepared by coating, on an alignment film, a liquid crystal composition (coating liquid) containing liquid crystalline molecules, a following polymerization initiator and arbitrary additives (such as a plasticizer, a monomer, a surfactant, a cellulose ester, a 1,3,5-triazine compound, an optically active compound, an air-interface alignment controlling agent, and an antirepellency agent). An organic solvent is preferably employed as a solvent for preparing the liquid crystal composition. Examples of the organic solvent include an amide (such as N,N-dimethylformamide), a sulfoxide (such as dimethyl sulfoxide), a heterocyclic compound (such as pyridine), a hydrocarbon (such as benzene or hexane), an alkyl halide (such as chloroform, or dichloromethane), an ester (such as methyl acetate, or butyl acetate), a ketone (such as acetone or methyl ethyl ketone), and an ether (such as tetrahydrofuran, or 1,2-dimethoxyethane). Two or more organic solvents may be employed in combination. The liquid crystal composition can be coated by a known method (such as a wired bar coating, an extrusion coating, a direct gravure coating, a reverse gravure coating or a die coating).

The polymerization reaction of the liquid crystal compound includes a thermal polymerization reaction utilizing a thermal polymerization initiator and a photopolymerization reaction utilizing a photopolymerization initiator, and a photopolymerization reaction is more preferable. Examples of the photopolymerization initiator include an α-carbonyl compound (such as those described in U.S. Pat. Nos. 2,367,661 and 2,347,670), an acyloin ether (such as described in U.S. Pat. No. 2,448,828), an α-hydrocarbon substituted aromatic acyloin compound (such as described in U.S. Pat. No. 2,722,512), a polynucleic quinone compound (such as described in U.S. Pat. Nos. 3,046,127 and 2,951,758), a combination of a triarylimidazole dimer and p-aminophenyl ketone (such as described in U.S. Pat. No. 3,549,367), acridine and phenazine compounds (such as described in JP-A No. 60-105667 and U.S. Pat. No. 4,239,850), and an oxadiazole compound (such as described in U.S. Pat. No. 4,212,970). An amount of the photopolymerization initiator is preferably 0.01 to 20 wt. % with respect to the solid of the coating liquid, and more preferably 0.5 to 5 wt. %. A light irradiation for polymerizing the liquid crystalline molecules is preferably executed with an ultraviolet light. An irradiating energy is preferably 20 to 50 J/cm², and more preferably 100 to 800 mJ/cm². The light irradiation may be executed under heating, in order to accelerate the photopolymerization reaction. The optically anisotropic layer preferably has a thickness of 0.1 to 20 μm, more preferably 0.5 to 15 μm and most preferably 1 to 10 μm. Also in case plural optically anisotropic layers are provided, it is preferable that each independently has the aforementioned thickness.

(Optically Active Compound)

A chiral biaxial nematic phase can be expressed by mixing an optically active compound with a liquid crystal compound capable of expressing a biaxial nematic phase. The chiral biaxial nematic phase can also be expressed by a liquid crystal compound having an asymmetric center.

The optically active compound can be a known chiral agent (described for example in Liquid Crystal Device Handbook, Chap. 3, 4-3, Chiral agent for TN and STN, p. 199, Nippon Gakujutsu Shinko-kai, Committee No. 142, 1989). The optically active compound generally contains an asymmetric carbon atom, but an axially asymmetric compound or a planar asymmetric compound, not containing an asymmetric carbon atom, may also be employed as a chiral agent. Examples of the axially asymmetric compound and the planar asymmetric compound include binaphthyl, helicene, paracyclophane and derivatives thereof. The optically active compound (chiral agent) may include a polymerizable group.

An amount of the optically active compound is preferably 0.01 to 200 mol. % of the amount of the liquid crystal compound capable of expressing a biaxial nematic phase.

(Air-Interface Alignment Controlling Agent)

The liquid crystal composition is aligned, at an air interface, with a tilt angle of the air interface. Such tilt angle is variable depending on the type of the liquid crystal compound and the type of additives contained in the liquid crystal composition, it is necessary to arbitrarily control the tilt angle at the air interface, according to the purpose.

The tilt angle can be controlled by an external field such as an electric field or a magnetic field or an additive, and the use of an additive is preferable. Such additive is preferably a compound having a substituted or non-substituted aliphatic group with 6 to 40 carbon atoms or a substituted or non-substituted aliphatic-substituted oligosiloxanoxy group with 6 to 40 carbon atoms by one or more units within a molecule, and more preferably a compound having such group by two or more units with a molecule. For example, as an air-interface alignment controlling agent, there can be utilized a hydrophobic volume-extrusion effect compound described in JP-A No. 2002-20363.

The additive for controlling the alignment at the air interface is preferably employed in an amount of 0.001 to 20 mass % (weight %) with respect to the liquid crystal composition of the invention, more preferably 0.01 to 10 mass % and most preferably 0.1 to 5 mass %.

(Antirepellency Agent)

In the liquid crystal composition of the invention, a polymer compound can be advantageously employed as a material for preventing a liquid repellency at the coating of the composition.

The polymer to be employed is not particularly restricted as long as it does not significantly hinder a change in the inclination angle or an alignment in the liquid crystal composition of the invention.

Examples of the polymer are described in JP-A No. 8-95030, and particularly preferably a cellulose ester. Examples of the cellulose ester include cellulose acetate, cellulose acetate propionate, hydroxypropyl cellulose and cellulose acetate butyrate.

In order not to hinder the alignment of the liquid crystal composition of the present invention, the polymer employed for the purpose of antirepellency is used in an amount generally of 0.1 to 10 mass % with respect to the liquid crystal composition of the invention, preferably 0.1 to 8 mass % and more preferably 0.1 to 5 mass %.

(Transparent Substrate)

As a transparent substrate of the optical compensation film, there is employed a glass plate or a polymer film, preferably a polymer film. A transparency of the substrate means that it has an optical transmittance of 80% or higher. In case of giving emphasis to the relaxation of gray-scale inversion, the transparent substrate is more preferably constituted of an optical isotropic polymer film. The optical isotropy specifically means an in-plane retardation (Re) less than 10 nm, preferably less than 5 nm. Also in an optically isotropic transparent substrate, a retardation (Rth) in a direction of thickness is also preferably less than 10 nm, more preferably less than 5 nm. In the transparent substrate, an in-plane retardation (Re) and a retardation (Rth) in thickness direction are defined respectively by following equations:
Re=(nx−ny)×d
Rth=({(x+ny)/2}−nz)×d
wherein nx and ny are elongational refractive indexes of the transparent substrate; nz is a refractive index in the direction of thickness of the transparent substrate; and d is a thickness of the transparent substrate.

In case of giving emphasis to an enlargement of the viewing angle in a display, an optically anisotropic polymer film may be effective as the transparent substrate. This is a case of optically compensating the liquid crystal cell by the optical anisotropy of the optically anisotropic layer together with the optical anisotropy of the transparent substrate. In such case, the transparent substrate preferably has an optical monoaxial property or an optical biaxial property. In a substrate having an optical monoaxial property, it may be optically positive, namely having a refractive index in a direction of optical axis larger than a refractive index in a direction perpendicular to the optical axis, or optically negative, namely having a refractive index in a direction of optical axis smaller than a refractive index in a direction perpendicular to the optical axis. In a substrate having an optical biaxial property, the refractive indexes nx, ny and nz in the aforementioned equations assume all different values (nx≠ny≠nz). An optically anisotropic transparent substrate preferably has an in-plane retardation (Re) of 10-100 nm, more preferably 10-50 nm and most preferably 10-30 nm. The optically anisotropic transparent substrate preferably has a retardation (Rth) in the thickness direction of 10-200 nm, more preferably 10-100 nm and further preferably 10-50 nm.

A material constituting the transparent substrate can be determined according whether to prepare an optically isotropic substrate or an optically anisotropic substrate. In case of an optically isotropic substrate, glass or a cellulose ester is generally employed. In case of an optically anisotropic substrate, there is generally employed a synthetic polymer (such as polycarbonate, polysulfone, polyethersulfone, polyacrylate, polymethacrylate, or a norbornene resin). However, a cellulose ester film of an optically anisotropic property (high retardation) can also be prepared by (1) use of a retardation elevating agent, (2) a reduction in an acetylation degree of the cellulose acetate, or (3) a film production by a cooled dissolving method, as described in EP No. 0911656A. The transparent substrate constituted of a polymer film is preferably formed by a solvent casting method.

In order to obtain an optically anisotropic transparent substrate, an extending process is preferably applied to the polymer film. In case of producing an optically monoaxial substrate, an ordinary monoaxial or biaxial extending process may be executed. In case of producing an optical biaxial substrate, an unbalanced biaxial extending process is preferably executed. In an unbalanced biaxial extending process, it is preferable to extend a polymer film in a certain direction by a predetermined rate, for example by 3-100%, preferably 5-30%, and to extend the film in a perpendicular direction by a larger rate, for example 6-200%, preferably 10-90%. The extending processes in two directions may be executed one by one or at the same time. The extending direction (a direction of a higher extending rate in case of an unbalanced biaxial extension) is preferably substantially same as a phase retarding axis in the plane of the film after extending operation. The substantially same direction means that an angle between the extending direction and the phase retarding direction is preferably less than 10°, more preferably less than 5° and most preferably less than 3°.

(Alignment Film)

An alignment film can be provided by a rubbing process of an organic compound (preferably a polymer), an inclined evaporation of an inorganic compound, a formation of a layer having microgrooves, or a deposition, by Langmuir-Bloggette (LB) method, of an organic compound (such as (ω-tricosanic acid, dioctadecylmethylammonium chloride or methyl stearate). There is also known an alignment film capable of exhibiting an aligning ability by an electrical field, a magnetic field or a light irradiation. An alignment film formed by a rubbing process of a polymer is particularly preferable. The rubbing process is executed by rubbing a surface of a polymer layer with a paper or a cloth several times in a fixed direction. A type of the polymer to be employed in the alignment film is determined according to the alignment (particularly an average inclination angle) of the liquid crystalline molecules. In order to align the liquid crystalline molecules in a relatively horizontal direction (average inclination angle: 0-50°), there is employed a polymer that does not lower a surface energy of the alignment film (such as a polymer for an ordinary alignment film). In order to align the liquid crystalline molecules in a relatively vertical direction (average inclination angle: 50-90°), there is employed a polymer that lowers the surface energy of the alignment film. In order to lower the surface energy of the alignment film, it is preferable to introduce a hydrocarbon group with 10 to 100 carbon atoms in a side chain of the polymer.

Specific types of the polymer are described in literatures on the optical compensation films utilizing liquid crystalline molecules corresponding to various liquid crystal display modes. The alignment film preferably has a thickness of 0.01 to 5 μm, and more preferably 0.05 to 1 μm. It is also possible to align the liquid crystalline molecules of the optically anisotropic layer with an alignment film and then to transfer the optically anisotropic layer onto the transparent substrate. The liquid crystalline molecules fixed in an aligned state can maintained such aligned state even without the alignment film. An alignment with an average inclination angle less than 5° does not require a rubbing process nor an alignment film. However, in order to improve the adhesion between the liquid crystalline molecules and the transparent substrate, an alignment film capable of forming a chemical bond with the liquid crystalline molecules at the interface (for example described in JP-A No. 9-152509) may be employed. In case of employing an alignment film for the purpose of improving the adhesion, a rubbing process may be dispensed with. In case of forming optically anisotropic layers of two types on a same side of the transparent substrate, it is also possible to utilize an optically anisotropic layer, provided on the transparent substrate, as an alignment film for another optically anisotropic layer to be provided thereon.

(Polarizing Film)

A polarizing film includes an iodine-based polarizing film, a dye-based polarizing film employing a dichroic dye, and a polyene-based polarizing film. The iodine-based polarizing film and the dye-based polarizing film is generally produced with a polyvinyl alcohol-based film. A polarizing axis of the polarizing film corresponds to a direction perpendicular to the extending direction of the film. A polarizing axis along the plane of the polarizing film is preferably positioned substantially perpendicular to an average direction of a line obtained by projecting a longer axis direction of the rod-shaped liquid crystalline molecules onto the transparent substrate.

(Transparent Protective Film)

A transparent polymer film is employed as a transparent protective film. A transparency of the protective film means that it has an optical transmittance of 80% or higher. The transparent protective film is generally formed by a cellulose ester film, preferably a triacetyl cellulose film. The cellulose ester film is preferably formed by a solvent cast method. The transparent protective film preferably has a thickness of 20-500 μm, more preferably 50-200 μm.

(Liquid Crystal Display)

The present invention is particularly effective in a liquid crystal display of TN mode. The liquid crystal cell of TN mode is utilized in the most popular color TFT liquid crystal display, described in various literatures and can be utilized widely in such displays.

In the liquid crystal display of TN mode, in a non-driven state where a driving voltage is not applied to driving electrodes, the liquid crystalline molecules in the liquid crystal cell are aligned approximately parallel to the surface of the substrates, and the direction alignment is twisted by 90° between the upper and lower substrates. With an increase in an applied voltage, the liquid crystalline molecules gradually stand up in a direction perpendicular to the substrates, while diminishing the twisted state.

The liquid crystal layer preferably has a product Δn·d of a thickness d (μm) and a refractive index anisotropy An within a range of 0.2-0.5 μm. Also a twist angle of the liquid crystal layer is optimally about 90° (85-95°). Within such ranges, there can be obtained a high brightness in a white display and a low brightness in a black display, thereby providing a display apparatus of a high contrast. These optimum values apply to a transmission mode in a reflective mode, since the optical path length in the liquid crystal cell is doubled, the optimum Δn·d value becomes about ½ and the optimum twist angle becomes about 30-70°.

The liquid crystal display of the invention is not restricted to the configuration shown in FIGS. 2 to 5, but may include other members. For example, a color filter may be provided between the liquid crystal cell and the polarizing film. Also in case of use as a transmission type, there may be provided a backlight source such as of a cold or hot cathode fluorescent tube, a field emission device or an electroluminescent device. Also the liquid crystal display of the invention can be utilized as a reflective type, in which case the polarizing plate is provided in one unit at the observing side, and a reflecting film is provided behind the liquid crystal cell or on an internal surface of the lower substrate of the liquid crystal cell. It is naturally possible to provide a frontlight, utilizing the aforementioned light source, at the observing side of the liquid crystal cell. Furthermore, the liquid crystal display of the invention may be a semi-transmission type having a reflecting part and a transmitting part within a pixel, in order to achieve a transmission mode and a reflective mode at the same time.

The liquid crystal display of the invention includes, for example, a direct image observing type, an image projection type and a light modulation type.

The present invention is particularly effective in an embodiment applied to an active matrix liquid crystal display, utilizing 3- or 2-terminal semiconductor devices such as TFT or MIM.

Now an operation of the liquid crystal display shown in FIGS. 4A-4D will be explained, taking a TN mode as an example. In the present embodiment, there will be explained a case of an active drive with a nematic liquid crystal having a positive dielectric anisotropy. In the TN mode, a liquid crystal cell is prepared, between upper and lower substrate 6a, 6b, by a rubbed alignment of a liquid crystal having a positive dielectric anisotropy, a refractive index anisotropy Δn=0.0854 (589 nm, 20° C.) and a dielectric anisotropy Δε of about +8.5. The alignment of the liquid crystal is controlled by an alignment film and a rubbing. A director indicating an alignment direction of the liquid crystalline molecules, or so-called tilt angle, is preferably selected as about 3°. The rubbing is executed in mutually orthogonal direction respectively on the upper and lower substrates, and the magnitude of the tilt angle can be controlled by an intensity and a number of rubbing operations. The alignment film is formed by coating and baking a polyimide film. A magnitude of a twist angle of the liquid crystal layer is determined by a crossing angle of the rubbing directions on the upper and lower substrates, and by a chiral agent added to the liquid crystal material. In the present case, a chiral agent of a pitch of about 60 μm in order to obtain a twist angle of 90°. Also a thickness d of the liquid crystal layer is selected as 5 μm.

The liquid crystal material LC is not restricted as long as it is a nematic liquid crystal. The dielectric anisotropy Δε is preferably larger, in order to reduce the driving voltage. Also a smaller refractive index anisotropy Δn allows to increase the thickness (gap) of the liquid crystal layer, thereby effectively reducing a fluctuation in the gap. Also a larger Δn allow to reduce the cell gap, thereby effectively enabling a high-speed response.

Layers are positioned in such a manner that a polarizing axis of an upper polarizing film 2b and a polarizing axis of a lower polarizing film 2a are approximately perpendicular, that the polarizing axis of the upper polarizing film 2b is approximately parallel to a rubbing direction of an upper substrate 6b and that the polarizing axis of the lower polarizing film 2a is approximately parallel to a rubbing direction of a lower substrate 6a. At the inner sides of the alignment films of the upper substrate 6a and the lower substrate 6b, transparent electrodes (not shown) are formed. In a non-driven state where a driving voltage is not applied to the electrodes, the liquid crystalline molecules in the liquid crystal cell are aligned substantially parallel to the surface of the substrates, whereby a light transmitted by the liquid crystal panel propagates with a polarization state along the twisted structure of the liquid crystalline molecules and emerges from the panel with a 90° rotated polarizing plane. Thus the liquid crystal display executes a white display in a non-driven state. On the other hand, in a driven state, the liquid crystalline molecules are aligned in a direction of a certain angle to the substrate surface, whereby a light transmitted by the lower polarizing film 2a passes through the liquid crystal layer 7 while maintaining its polarized state, and is intercepted by the polarizing film 2b. Stated differently, the liquid crystal display provides an ideal black display in a driven state.

It is also possible to lower a driving voltage for the liquid crystal display, thereby reducing a stand-up angle of the liquid crystalline molecules in the liquid crystal cell of TN mode.

### EXAMPLES

### Synthesis Example 1

### Synthesis of Liquid Crystal Compound Example D-8 Having a Polymerizable Group and Capable of Expressing Discotic Liquid Crystal Phase

A compound D-8 was synthesized according to a following scheme.

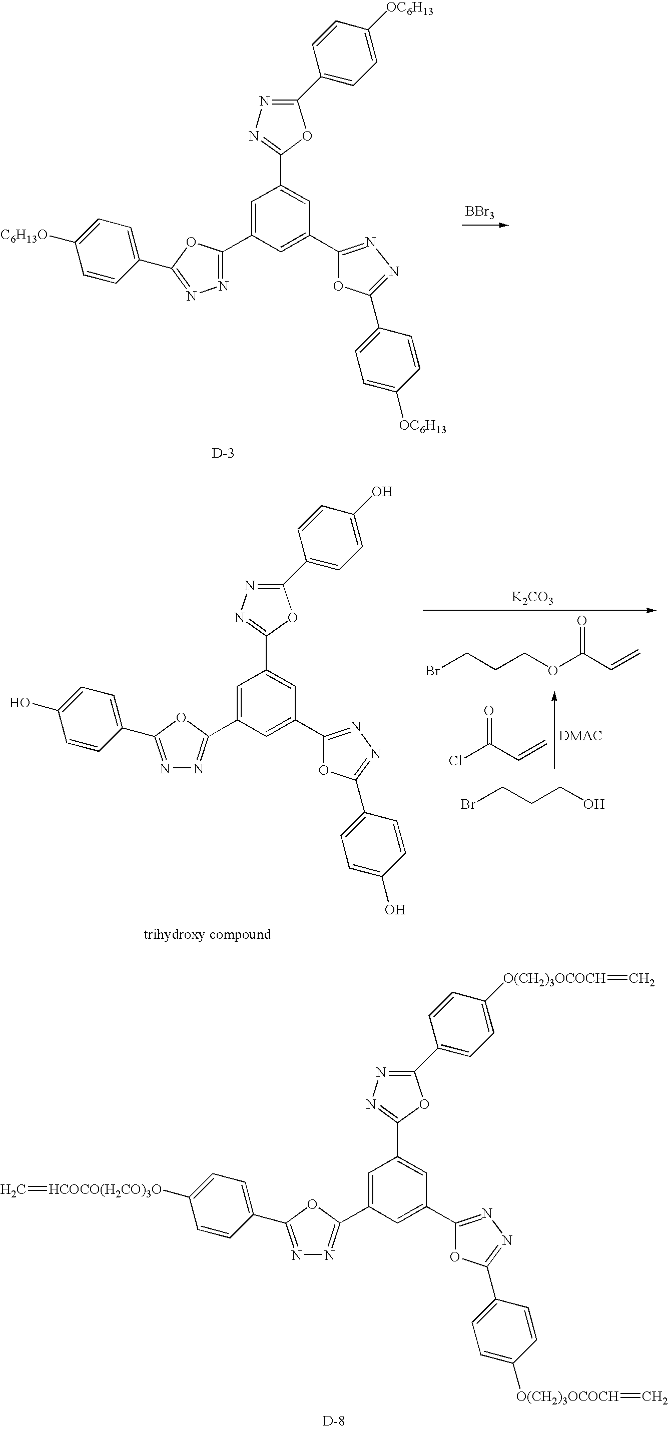

5.0 g of a compound (D-3) synthesized according to a method described in a literature (Kim, Bong Gi et al., Molecular Crystals and Liquid Crystals, 2001, vol. 370, p. 391) were dissolved in 100 ml of CH₂Cl₂, and 75 ml of boron tribromide (1.0 M solution in CH₂Cl₂) were added. After agitation for 12 hours at 40° C., water was added to the reaction liquid and precipitating crystals were separated by filtration. The obtained crystals were dried to obtain 3.0 g of trihydroxy compound.

5 g of 3-bromo-1-propanol were dissolved in 20 ml of dimethylacetamide, and 3.8 ml of acryloyl chloride were dropwise added at a reaction temperature of 40° C. or less. After agitation for 1 hour, 200 ml of water were added, and an extraction was made with ethyl acetate/hexane. After the layers were separated, the organic layer was distilled off, 0.5 g of the aforementioned trihydroxy compound, 2.0 g of potassium carbonate and dimethylformamide were added and the mixture was agitated for 10 hours at 100° C.

Water was added to the reaction liquid which was then extracted with CH₂Cl₂. The organic layer was concentrated and purified with a column chromatography to obtain 0.8 g of white crystals of D-8.
¹H-NMR (solvent:CDCl₃, reference: tetramethylsilane) δ(ppm):
2.15-2.30 (6H, m)
4.18 (6H, t)
4.43 (6H, t)
5.86 (3H, d)
6.16 (3H, dd)
6.45 (3H, d)
7.08 (3H, d)
8.16 (6H, d)
9.02 (3H, s).

A phase transition temperature of the obtained D-8 was measured by a texture observation under a polarizing microscope. With an increase in the temperature, it shifted from a crystalline phase to a discotic nematic phase at about 125° C., and further shifted to an isotropic liquid phase beyond 149° C. Thus D-8 was found to express a discotic nematic phase between 125 and 149° C.

### Synthesis Example 2

### Synthesis of Plate-Shaped Liquid Crystal Compound TO-3 Expressing Rod-Shaped Liquid Crystal Phase

A compound TO-3 was synthesized according to a following scheme. 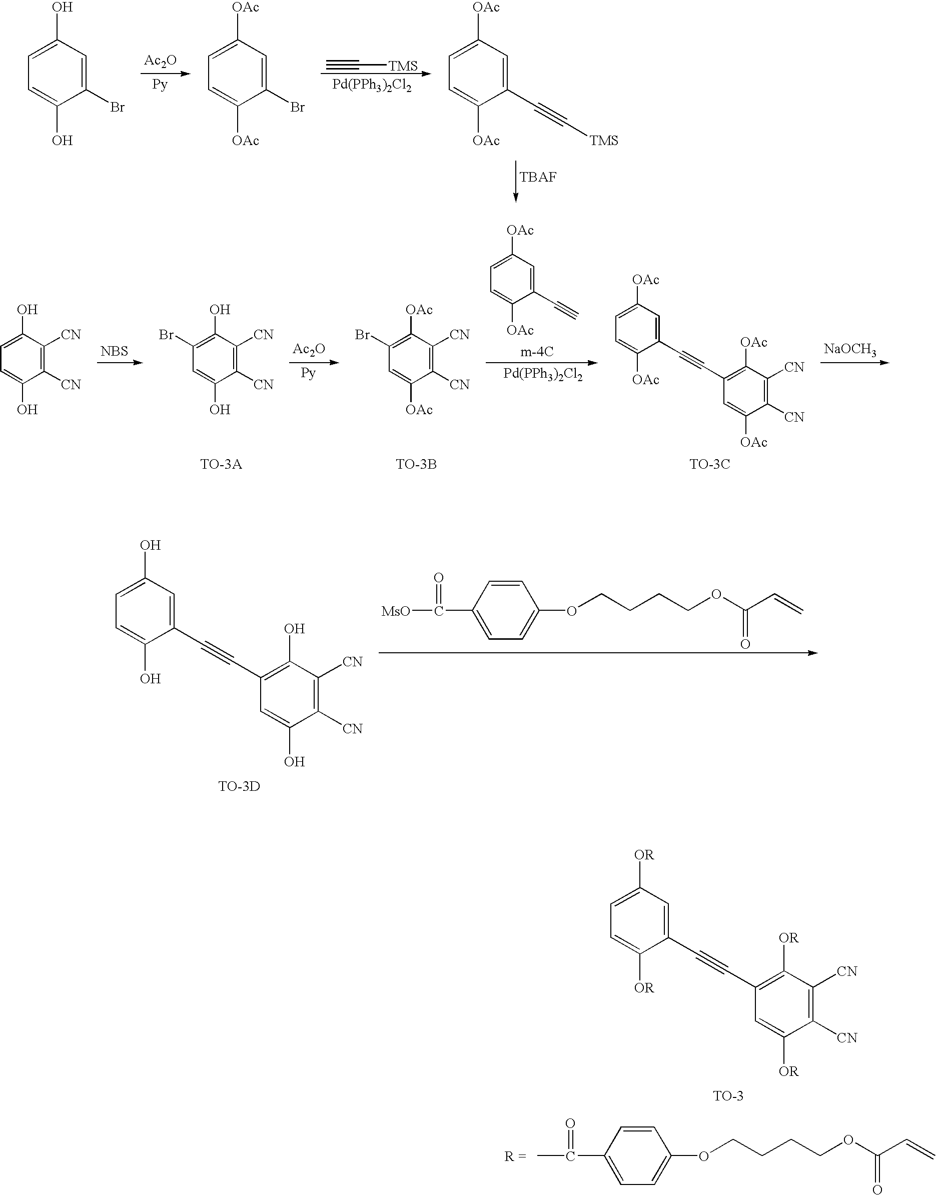
(synthesis of m-4A)

25.0 g of bromohydroquinone were dissolved in 70 ml of pyridine (Py), and 37 ml of acetic anhydride (Ac₂O) were dropwise added at a reaction temperature of 50° C. or lower. After agitation for 3 hours, water was added to the reaction liquid and an extraction was executed with ethyl acetate. An obtained organic layer was washed with a saturated aqueous solution of sodium bicarbonate, a dilute hydrochloric acid, water and a saturated aqueous solution of sodium chloride and the solvent was distilled off under a reduced pressure. A crystallization from hexane was conducted to obtain 32.2 g of crystals of a compound m-4A.

(synthesis of m-4B)

32.2 g of m-4A, 17.4 g of trimethylsilyl (TMS) acetylene, 0.5 g of triphenylphosphine, 0.25 g of bis(triphenylphosphine) palladium (II) dichloride and 80 mg of copper (I) iodide were dissolved in 200 ml of triethylamine, and the mixture was refluxed for 10 hours in a nitrogen atmosphere. After cooling, the precipitating triethylamine hydrochloride salt was filtered off, and an organic layer was distilled under a reduced pressure. An obtained residue was purified by a column chromatography to obtain 32.0 g of crystals of a compound m-4B.

(synthesis of m-4C)

32.0 g of m-4B were dissolved in 200 ml of tetrahydrofuran, then 120 ml of a tetrahydrofuran solution (1.0 M) of tetrabutyl ammonium fluoride (TBAF) were added, and the mixture was agitated for 30 minutes at the room temperature. Then water was added to the reaction mixture, which was extracted with ethyl acetate, and the extract was washed with a saturated aqueous solution of sodium chloride. The organic layer was concentrated under a reduced pressure, and purified by a column chromatography to obtain 20.5 g of crystals of a compound m-4C.

(Synthesis of TO-3A)

20.4 g of 2,3-dicyanohydroquinone were dissolved in 150 ml of t-butanol, then 22.6 g of NBS (N-bromosuccinimide) were added and the mixture was agitated for 4 hours at the room temperature. The reaction liquid was added to 1 L of water, and, after the precipitating crystals were filtered off, the filtrate was added with concentrated hydrochloric acid and extracted with ethyl acetate. The organic layer was concentrated under a reduced pressure and purified by a column chromatography to obtain 8.5 g of a compound TO-3A.

(Synthesis of TO-3B)

8.0 g of TO-3A were dissolved in 50 ml of tetrahydrofuran, and 25 ml of pyridine (Py) and 20 ml of acetic anhydride (AC₂O) were dropwise added. After agitation for 12 hours, the reaction liquid was added to 1 L of water, and precipitating crystals were separated by filtration and dried. Obtained crystals were purified by a column chromatography to obtain 9.7 g of a compound TO-3B.

(Synthesis of TO-3C)

3.0 g of TO-3B, 2.43 g of m-4c obtained as described above, 60 mg of triphenylphosphine, 30 mg of bis(triphenylphosphine) palladium (II) dichloride and 10 mg of copper (I) iodide were dissolved in 100 ml of triethylamine, and the mixture was refluxed for 5 hours at 60° C. in a nitrogen atmosphere. After cooling, methanol was added to the reaction liquid and precipitating crystals were separated by filtration and dried. Otained crystals were purified by a column chromatography to obtain 1.7 g of a compound TO-3B.

(Synthesis of TO-3D)

1.7 g of TO-3C were dissolved in 40 ml of tetrahydrofuran, and 5 ml of sodium methoxide (28% methanol solution) and 20 ml of methanol were added under bubbling with nitrogen. After agitation for 30 minutes at the room temperature, dilute hydrochloric acid was added to the reaction mixture, which was then extracted with ethyl acetate. An obtained organic layer was distilled under a reduced pressure to obtain 1.0 g of a compound TO-3D.

(Synthesis of TO-3)

0.43 g of methanesulfonyl chloride were dissolved in 10 ml of tetrahydrofuran and was cooled to 0° C. To this solution, 1.0 g of 4-(4-acryloyloxybutyloxy)benzoic acid and a solution of 0.51 g of diisopropylamine in 10 ml of tetrahydrofuran were dropwise added. After agitation for 1 hour at 0° C., 0.51 g of diisopropylethylamine, and 0.02 g of 4-dimethylaminopyridine were added, and a solution of 0.14 of TO-3D in 10 ml of tetrahydrofuran was added. After agitation for 12 hours at the room temperature, water was added to the reaction liquid, which was then extracted with CH₂Cl₂. The extract, after concentration under a reduced pressure, was purified by a column chromatography to obtain 0.32 g of white crystals of TO-3. The obtained TO-3 showed an NMR spectrum as follows.

¹H-NMR (solvent: CDCl₃, reference: tetramethylsilane): δ(ppm):
1.70-1.90 (8H, m)
1.90-2.00 (8H, m)
3.90-4.00 (4H, m)
4.08-4.18 (4H, m)
4.19-4.30 (8H, m)
5.80-5.90 (4H, m)
6.07-6.20 (4H, m)
6.36-6.48 (4H, m)
6.90-7.05 (9H, m)
7.25 (1H, dd)
7.32 (1H, d)
7.47 (1H, d)
8.06-8.20 (8H, m)
   (0170)

A phase transition temperature of the obtained TO-3 was measured by a texture observation under a polarizing microscope. With an increase in the temperature, it shifted from a crystalline phase to a nematic liquid crystal phase at about 122° C., and further shifted to an isotropic liquid phase beyond 195° C. Thus TO-3 was found to express a nematic liquid crystal phase between 122 and 195° C.

### Example 1

### Confirmation of Biaxial Nematic Phase

0.225 g of (D-8) and 0.100 g of (TO-3) were dissolved in CH₂Cl₂ and then the solvent was evaporated to obtain (BAmix-1), which proved, in an observation under a polarizing microscope, to express a nematic phase at 100° C. or lower in a temperature descent from 150° C.

Then the (BAmix-1) was poured, at 110° C., into a horizontally aligned cell of a cell gap of 5 μm (KSRP-05/A107MINss(ZZ), manufactured by EMC Co.), and shifted to a nematic phase upon cooling to 100° C. thereby showing a homeotropic alignment and exhibiting a dark viewing field. A further temperature descent to 80° C. caused a shift of the liquid crystal to a biaxial nematic phase. The liquid crystal was maintained at 80° C. for 3 minutes and was subjected to a measurement of an angle dependence of the retardation, and (nx−nz)/(nx−ny) was determined as 4.0.

### Example 2

### Preparation of Optical Compensation Film

(Preparation of Undercoat Layer/Transparent Substrate)

A triacetyl cellulose film (thickness: 100 μm) (Fujitac TD-80U, manufactured by Fuji Photo Film Co.) was employed as a transparent substrate, which had Re of 1 nm and Rth of 48 nm. The transparent substrate was coated on both sides thereof with gelatin with a thickness of 0.1 μm to form first and second undercoat layers.

(Preparation of First Alignment Film)

On the first alignment film, an aqueous solution containing following denatured polyvinyl alcohol by 2 wt. % and glutaraldehyde by 0.1 wt. %, then dried with a warm air of 80° C. and subjected to a rubbing process to obtain a first alignment film.

denatured polyvinyl alcohol 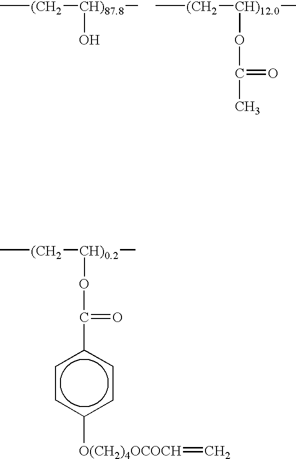
(Formation of Optically Anisotropic Layer)

On thus prepared alignment film after rubbing, an optically anisotropic layer coating liquid of a following composition was coated with a spin coater.

(Optically anisotropic layer coating liquid)

| | | |
|---|---|---|
| liquid crystal compound D-8 | 69.2 | parts by mass |
| | | (by weight) |
| liquid crystal compound TO-3 | 30.8 | parts by mass |
| air-interface alignment controlling agent V-(1) | 0.2 | parts by mass |
| polymerizable optically active compound | 1 | part by mass |
| chloroform | 700 | parts by mass |

air-interface alignment controlling agent V-(1)

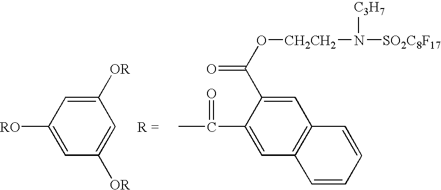

polymerizable optically active compound

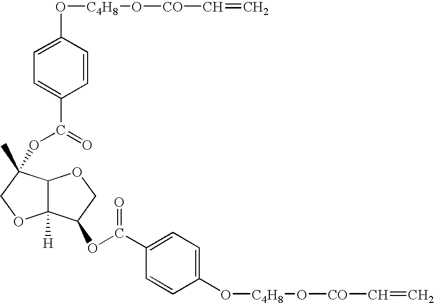

The substrate coated with the aforementioned optically anisotropic layer was heated to 120° C. in a thermostat tank of 130° C., then cooled to 95° C. and maintained at this temperature for 2 minutes. It was then placed in a thermostat tank of 80° C. with an oxygen concentration of 2%, and subjected, after 5 minutes, to an ultraviolet irradiation of 600 mJ to fix the aligned state of the optically anisotropic layer. It was then let cool to the room temperature to obtain an optical compensation film. The optically anisotropic layer had a thickness of 1.2 μm. Also in a measurement of an angle dependence of the retardation of the obtained optical compensation film, a change in the direction of film thickness was observed in the directions of nx and nz. A twist angle was measured as 1°.

(Preparation of Liquid Crystal Display)

A polyimide alignment film was provided on a glass substrate bearing an ITO transparent electrode, and was subjected to a rubbing process. Then two substrates were superposed across a spacer in such a manner that the alignment films are mutually opposed. The two substrates were so positioned that the rubbing directions of the alignment films are mutually orthogonal. Into the gap between the substrates, rod-shaped liquid crystalline molecules (ZL4792, manufactured by Merck Inc.) were poured to form a rod-shaped liquid crystal layer. The rod-shaped liquid crystalline molecules had Δnd of 420 nm.

On both sides of thus prepared TN liquid crystal cell, two optical compensation films prepared in Example 2 were adhered in such a manner that the optically anisotropic layer was opposed to the substrate of the liquid crystal cell. Then two polarizing plates were adhered on both outsides to obtain a liquid crystal display. The rubbing direction of the alignment film of the optical compensation sheet was positioned antiparallel to the rubbing direction of the adjacent alignment film of the liquid crystal cell. Also an absorbing axis of the polarizing plate was provided parallel to the rubbing direction of the liquid crystal cell. As a result, it was confirmed that the viewing angle could be widened and that the display did not show a coloration.

### Comparative Example 1

A liquid crystal display was prepared in the same manner as in Example 2, except that the polymerizable optically active compound was not employed. A twist angle was measured as 0.0°.

### Comparative Example 2

A liquid crystal display was prepared by removing the two optical compensation films from the apparatus of Example 2.

The liquid crystal displayes, prepared as described above, were subjected to a measurement of optical characteristics, by applying a voltage with a function generator (FG-281, manufactured by Kenwood TMK Co.) and utilizing a variable-angle goniophotometer (GSP-3B, manufactured by Murakami Shikisai Gijutsu Kenkyusho Co.). Luminance-viewing angle characteristics and contrast-viewing angle characteristics were measured with voltages at 8 levels equally divided between a black display state (L0) and a white display state (L7) seen from the front direction. An angle where the luminances L1 and L2 mutually cross (angle showing a gray-scale inversion) at a lower side of the vertical direction and a viewing angle range providing a contrast ratio of 20:1 are shown in Table 1.

TABLE 1

| | viewing angle | viewing angle | angle (°) of |
|---|---|---|---|
| | (°) in | (°) in | gray-scale |
| | vertical | lateral | inversion at |
| | direction | direction | lower side |
| Example 2 | 160 | 116 | 37 |
| Comp. Ex. 1 | 150 | 115 | 29 |
| Comp. Ex. 2 | 80 | 64 | 29 |

| | functional evaluation |
|---|---|
| Example 2 | Contrast viewing angle was wide, and a satisfactory result |
| | for gray-scale inversion at the lower side |
| Comp. Ex. 1 | Contrast viewing angle was wide, but an unsatisfactory |
| | result for gray-scale inversion at the lower side |
| Comp. Ex. 2 | Contrast viewing angle was narrow, and an unsatisfactory |
| | result for gray-scale inversion at the lower side |

The present invention is excellent in the viewing angle in the vertical direction, in the viewing angle in the lateral direction and in the angle of gray-scale inversion at the lower side, and is also excellent in the case without a retardation film and in a simple biaxial hybrid aligned film.

### Example 3

### Preparation of First Undercoat Layer/Transparent Substrate/Second Undercoat Layer

A triacetyl cellulose film (thickness: 100 μm) (Fujitac TD-80U, manufactured by Fuji Photo Film Co.) was employed as a transparent substrate, which had Re of 1 nm and Rth of 48 nm. The transparent substrate was coated on both sides thereof with gelatin with a thickness of 0.1 μm to form first and second undercoat layers.

(Preparation of First Alignment Film)

On the first alignment film, an aqueous solution containing following denatured polyvinyl alcohol by 2 wt. % and glutaraldehyde by 0.1 wt. %, then dried with a warm air of 80° C. and subjected to a rubbing process to obtain a first alignment film.

denatured polyvinyl alcohol 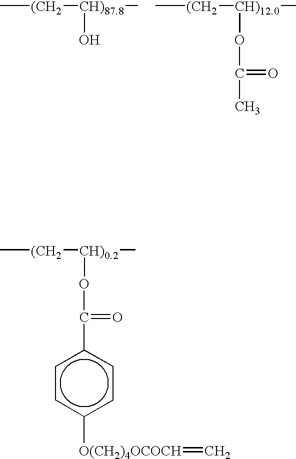
(Formation of First Optically Anisotropic Layer)

On thus prepared alignment film after rubbing, an optically anisotropic layer coating liquid of a following composition was coated with a spin coater. (0175)

(Optically anisotropic layer coating liquid)

| | | |
|---|---|---|
| liquid crystal compound D-8 | 69.2 | parts by mass |
| liquid crystal compound TO-3 | 30.8 | parts by mass |
| air-interface alignment controlling agent V-(1) | 0.2 | parts by mass |
| chloroform | 700 | parts by mass |

air-interface alignment controlling agent V-( 1)

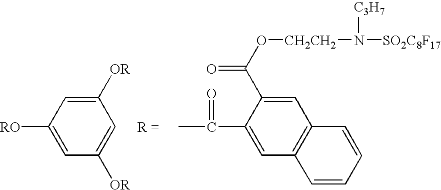

The substrate coated with the aforementioned optically anisotropic layer was heated to 120° C. in a thermostat tank of 130° C., then cooled to 95° C. and maintained at this temperature for 2 minutes. It was then placed in a thermostat tank of 80° C. with an oxygen concentration of 2%, and subjected, after 5 minutes, to an ultraviolet irradiation of 600 mJ to fix the aligned state of the optically anisotropic layer. It was then let cool to the room temperature to obtain an optical compensation film. The optically anisotropic layer had a thickness of 1.2 μm. Also in a measurement of an angle dependence of the retardation of the obtained optical compensation film, a change in the direction of film thickness was observed in the directions of nz and ny.

(Preparation of Second Alignment Film)

On the second undercoat layer on the opposite side of the transparent substrate, a commercially available solution of polyimide alignment film (SE-5291, manufactured by Nissan Chemical Co.) was coated with a #5 bar coater, then heated for 15 minutes at 80° C. and for 60 minutes at 130° C., and subjected to a rubbing process thereby obtaining a second alignment film of a thickness of 0.4 μm. The rubbing direction of the second alignment film was made perpendicular to that of the first alignment film.

(Preparation of Second Optically Anisotropic Layer)

100 parts by weight of rod-shaped liquid crystalline molecules (2), 1.0 part by weight of a photopolymerization initiator (Irgacure 907, manufacture by Nippon Ciba-Geigy Ltd.) and 0.3 parts by weight of a photosensitizer (Kayacure DETX, manufactured by Nippon Kayaku Co.) were dissolved in 900 parts by weight of methylene chloride to obtain a coating liquid. It was coated and dried on the second alignment film, and heated for 5 minutes at 110° C. to align the rod-shaped liquid crystalline molecules. It was then subjected to an ultraviolet irradiation of 500 mJ/cm² to polymerize the rod-shaped liquid crystalline molecules, thereby fixing the aligned state. The second optically anisotropic layer was subjected to a measurement, with an ellipsometer, of an in-plane retardation (Re). An average inclination angle β, determined from an angle dependence thereof, was 67°.

rod-shaped liquid crystalline molecule (2) 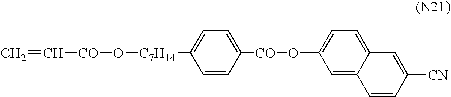
(Preparation of Elliptical Polarizing Plate Formed by First Optically Anisotropic Layer/First Alignment Film/First Undercoat Layer/Transparent Substrate/Second Undercoat Layer/Second Alignment Film/Second Optically Anisotropic Layer/Polarizing Film/Transparent Protective Film)

An elliptical polarizing plate was prepared by stacking a transparent protective film and a polarizing film on the aforementioned optical compensation film. An optical axis (average direction of a line obtained by projecting the direction of longer axis of the rod-shaped liquid crystalline molecules onto the transparent substrate) was positioned perpendicularly to the polarizing axis of the polarizing film.

(Preparation of Liquid Crystal Display)

A polyimide alignment film was provided on a glass substrate bearing an ITO transparent electrode, and was subjected to a rubbing process. Then two substrates were superposed across a spacer in such a manner that the alignment films are mutually opposed. The two substrates were so positioned that the rubbing directions of the alignment films are mutually orthogonal. Into the gap between the substrates, rod-shaped liquid crystalline molecules (ZL4792, manufactured by Merck Inc.) to form a rod-shaped liquid crystal layer. The rod-shaped liquid crystalline molecules had And of 420 nm.

On both sides of thus prepared TN liquid crystal cell, two optical compensation films prepared in Example 2 were adhered in such a manner that the first optically anisotropic layer was opposed to the substrate of the liquid crystal cell.

Then two polarizing plates were adhered on both outsides to obtain a liquid crystal display. The rubbing direction of the alignment film of the optical compensation sheet was positioned antiparallel to the rubbing direction of the adjacent alignment film of the liquid crystal cell. Also an absorbing axis of the polarizing plate was provided parallel to the rubbing direction of the liquid crystal cell.

As a result, it was confirmed that the viewing angle could be widened and that the display did not show a coloration.

### Example 4

A liquid crystal display was prepared in the same manner as in Example 3, except that the first optically anisotropic layer was prepared in the following manner.

(Preparation of First Optically Anisotropic Layer)

1.8 of a following discotic liquid crystal compound (1), 0.15 of ethylene oxide-denatured trimethylolpropane triacrylate (V#360, manufactured by Osaka Organic Chemical Industry Ltd.), 0.03 g of cellulose acetate butyrate (CAB551-0.2, Eastman Chemical Co.), 0.06 g of a photopolymerization initiator (Irgacure 907, manufactured by Nippon Ciba-Geigy Ltd.) and a photosensitizer (Kayacure DETX, manufactured by Nippon Kayaku Co.) were dissolved in 3.43 g of methyl ethyl ketone to obtain a coating liquid. The coating liquid was coated with a #3 wired bar on the first alignment film. In a state fixed by adhering on a metal frame, it was heated for 3 minutes in a thermostat tank of 120° C. to align the discotic liquid crystalline molecules. While a temperature of 120° C. was maintained, an ultraviolet irradiation was conducted for 1 minute with a high-pressure mercury lamp of 120 W/cm to polymerize the vinyl group of the discotic liquid crystalline molecule, thereby fixing the aligned state. Thereafter, the film was cooled to the room temperature. The first optically anisotropic layer thus formed had a thickness of 0.8 μm.

discotic liquid crystal compound (1)

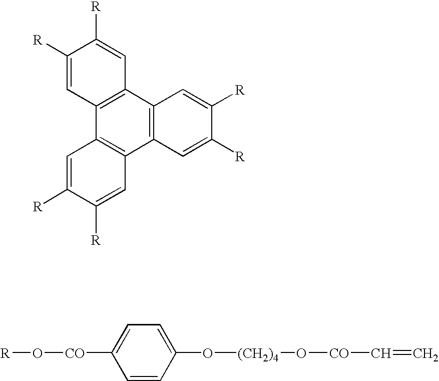

### Comparative Example 3

A liquid crystal display was prepared in the same manner as in Example 3, except that the second alignment film and the second optically anisotropic layer were not employed.

### Comparative Example 4

A liquid crystal display was prepared by removing the two optical compensation films from the apparatus of Example 3.

The liquid crystal displayes, prepared as described above, were subjected to a measurement of optical characteristics, by applying a voltage with a function generator (FG-281, manufactured by Kenwood TMK Co.) and utilizing a variable-angle goniophotometer (GSP-3B, manufactured by Murakami Shikisai Gijutsu Kenkyusho Co.). Luminance-viewing angle characteristics and contrast-viewing angle characteristics were measured with voltages at 8 levels equally divided between a black display state (L0) and a white display state (L7) seen from the front direction. An angle where the luminances L1 and L2 mutually cross (angle showing a gray-scale inversion) at a lower side of the vertical direction and a viewing angle range providing a contrast ratio of 20:1 are shown in Table 2.

Table 2

Example 3: hybrid alignment of biaxial liquid crystal+inclined alignment of monoaxial liquid crystal

Example 4: hybrid alignment of biaxial liquid crystal+inclined alignment of negative monoaxial liquid crystal

Comparative Example 3: hybrid alignment of biaxial liquid crystal

Comparative Example 4: no optically anisotropic film

| | viewing angle | viewing angle | angle (°) of |
|---|---|---|---|
| | (°) in | (°) in | gray-scale |
| | vertical | lateral | inversion at |
| | direction | direction | lower side |
| Example 3 | 160 | 155 | 38 |
| Example 4 | 160 | 140 | 38 |
| Comp. Ex. 3 | 159 | 115 | 29 |
| Comp. Ex. 4 | 80 | 64 | 29 |

| | functional inspection |
|---|---|
| Example 3 | Contrast viewing angle was wide, and a satisfactory result |
| | for gray-scale inversion at the lower side |
| Example 4 | Contrast viewing angle was wide, and a satisfactory result |
| | for gray-scale inversion at the lower side |
| Comp. Ex. 3 | Contrast viewing angle was wide, but an unsatisfactory |
| | result for gray-scale inversion at the lower side |
| Comp. Ex. 4 | Contrast viewing angle was narrow, and an unsatisfactory |
| | result for gray-scale inversion at the lower side |

In the table, the angle of gray-scale inversion at lower side means, in 8 luminance levels (L0-L7) equally divided between a black display state (L0) and a white display state (L7) seen from a normal direction to the display plane, an angle where the luminances L1 and L2 become equal when the viewing point is lowered from the normal direction to the lower side of the display.

The present invention is excellent in the viewing angle in the vertical direction, in the viewing angle in the lateral direction and in the angle of gray-scale inversion at the lower side, and is also excellent in the case without a retardation film and in a simple biaxial hybrid aligned film.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

This application is based on Japanese Patent Application Nos. JP2004-278125 and JP2004-279001, filed on September 24 and Sep. 27, 2004, respectively, the contents of which is incorporated herein by reference.

What is claimed is:

1. An optical compensation film comprising an optically anisotropic layer containing a liquid crystal composition capable of expressing a biaxial nematic phase, wherein the liquid crystal composition in the optically anisotropic layer is in a state where a hybrid alignment and a twisted alignment are provided.

2. An optical compensation film comprising an optically anisotropic layer containing a liquid crystal composition capable of expressing a biaxial nematic phase, wherein the optically anisotropic layer is formed by fixing the biaxial nematic phase in which a twisted alignment is provided to a hybrid alignment.

3. The optical compensation film according to claim 1, wherein the liquid crystal composition has refractive indexes nx, ny and nz in a decreasing order of three axes thereof, an angle of an axis of nx to a planar direction of the optical compensation film scarcely changes in a thickness direction of the optically anisotropic layer, and an angle of an axis of nz to the planar direction changes in the thickness direction.

4. The optical compensation film according to claim 1, wherein the twisted alignment has a twist angle of less than 10°.

5. The optical compensation film according to claim 1, wherein the liquid crystal composition comprises: a liquid crystal compound capable of expressing a rod-shape liquid crystal phase; and a liquid crystal compound capable of expressing a discotic liquid crystal phase.

6. The optical compensation film according to claim 1, wherein the liquid crystal composition comprises: an optically active compound; and a liquid crystal compound capable of expressing a biaxial nematic phase, the optical compensation film further comprises: a substrate; and an alignment film between the substrate and the optically anisotropoc layer, and the optically anisotropic layer is formed by: stacking a layer containing the liquid crystal composition; and expressing and fixing the biaxial nematic phase.

7. An optical compensation film comprising: a transparent substrate; a first optically anisotropic layer; and a second optically anisotropic layer in an arbitrary order, wherein the first optically anisotropic layer contains a liquid crystal composition capable of expressing a biaxial nematic phase, and the second optically anisotropic layer contains a monoaxial liquid crystalline molecule.

8. The optical compensation film according to claim 7, wherein the biaxial nematic phase expressed in the first optically anisotropic layer has a principal axis inclined to a surface of the transparent substrate.

9. The optical compensation film according to claim 8, wherein an inclination angle of the principal axis to the surface of the transparent substrate changes unidirectionally according to a distance to the surface of the transparent substrate.

10. The optical compensation film according to claim 7, wherein the monoaxial liquid crystalline molecule has an optical axis thereof inclined to a surface of the transparent substrate, and an inclination angle of the optical axis changes unidirectionally according to a distance to the surface of the transparent substrate.

11. The optical compensation film according to claim 7, wherein the first optically anisotropic layer, the transparent substrate and the second optically anisotropic layer are stacked in this order.

12. The optical compensation film according to claim 7, wherein the transparent substrate, the first optically anisotropic layer, and the second optically anisotropic layer are stacked in this order.

13. The optical compensation film according to claim 7, wherein the first optically anisotropic layer contains a rod-shape liquid crystalline molecule.

14. The optical compensation film according to claim 7, wherein the first optically anisotropic layer contains a discotic liquid crystalline molecule.

15. An elliptical polarizing plate comprises: a transparent substrate; an optical compensation film according to claim 1; and a polarizing film.

16. An elliptical polarizing plate comprising: at least an optical compensation film according to claim 7; a polarizing film; and a transparent protective film, wherein the second optically anisotropic layer is stacked in a position closer to the polarizing film than the first optically anisotropic layer.

17. A liquid crystal display comprising: a liquid crystal cell of TN mode; and two polarizing elements positioned on both sides of the liquid crystal cell, wherein the two polarizing elements each comprises an elliptical polarizing plate according to claim 16.

18. A liquid crystal display comprising an optical compensation film according to claim 1.
